(19) United States
(12) Patent Application Publication
(10) Pub. No.: US 2010/0223557 A1
(43) Pub. Date: Sep. 2, 2010

(54) Method and system for workflow integration

(76) Inventors: Adam Kenney, Frederick, MD (US); Phillip Henderson, Bloomfield Hills, MI (US); Jeffery A. Thompson, South Lyon, MI (US)

Correspondence Address: Valenti, Hanley & Robinson, PLLC, One Riverfront Plaza, 401 W. Main Street, Louisville, KY, 40202, US

(21) Appl. No.: 12/380,578

(22) Filed: Feb. 28, 2009

(51) Int. Cl. G06F 3/01; G06F 17/30; G06F 15/16

(52) U.S. Cl. 715/736; 709/203; 707/E17.044; 707/E17.014

(57) ABSTRACT

A system including a central server and a database for performing Intellectual Property (IP) management workflow processes is provided for creating, defining, and performing IP related workflow process. IP workflow routines present via a graphical user interface workflow screens to facilitate the exchange of data and instructions. An administration module is used to create authorized user accounts and assign roles and privileges involved in execution of IP workflow routines. A workflow creation module generates a user interface to facilitate creation of a user-defined IP workflow routine having user-defined workflow tasks to process IP related data received via user interface workflow screens. An IP management application may access, process and modify IP related data stored at the database while the IP workflow routines access and process IP related data stored at the database simultaneously with execution of the IP management application. Task modifiers associated with user-defined workflow tasks further define workflow routine operation.

### FIELD OF THE INVENTION

The present invention relates to computer-implemented business processes and, more particularly, to workflow assistance/enablement software as a tool for users in performance of business-related processes, including product development. The invention provides a workflow management system that enables users to create and execute tasks and to collaborate with others in performing business functions, including the management of Intellectual Property (“IP”).

### BACKGROUND

As companies continue to strive for efficiency, consistency and flexibility, computers and software executed on computers are increasingly relied upon to automate, semi-automate, enhance, quicken and make reliable and uniform business processes. As a result of rapidly expanding and increasingly cost-effective data storage and management capabilities and ever-increasing bandwidth in data communications, the appetite for increasingly robust software programs with greater access and use of business data has grown. Workflow Management Software (WMS) offers companies a tool to effect collaboration among users performing various business functions and situated both inside and outside the organization and at various locations to optimize, track and manage business processes. Business processes typically involve a systemic approach to identifying, tracking and sharing information, such as documents, forms, etc., and related tasks among participants identified and selected as having an interest in or role in advancing the process and ultimately a business related goal. The systemic approach may include a defined set of steps to be followed to advance the process and to effect the business related goal. Business processes often involve individuals, normally involved in data entry, review and decisioning, who may employ the use of computer programs and databases, to store information and assist in or make determinations, and electronic communications, to communicate documents, decisions, alerts, etc., to further the process. One exemplary business process is product life cycle. Included in the product life cycle is ideation of features or whole products and collecting and processing decisions respecting the identification, disclosure and securing of IP rights, including patent, trademark and copyright rights. In addition, companies have an increasing need to track and manage commercialization of IP rights, such as through licensing of rights to third-parties. In addition, ownership of IP rights across an entity having a plurality of entities by type and geographic location has implications in the payments of taxes associated with the rights, obtaining/granting the rights needed and licensing of the rights, including allocation of revenues and costs. The desire to perform business functions with these considerations with increased efficiency is ever present.

Organizations, as well as professional service providers serving such entities, often involve many employees and outside concerns in handling business processes. One example, is a team of engineers or other technical people who work on developing products and enhancements to products, the natural result of which is often patentable innovations. Typically, an inventor identifies inventions of interest and submits, via a written disclosure, their invention for consideration within the organization, often a patent review committee. The committee reviews the disclosure and makes a determination as to whether to pursue patent protection or not to pursue protection. Ultimately, in-house and/or outside counsel works with the inventors, and perhaps others, in preparing a patent application. The application typically undergoes a review process, often by receiving handwritten notes from reviewers, before being filed with a patent authority. Various considerations, such as prior disclosure of the invention or release of product incorporating the invention, must be tracked or docketed to insure timely filing of the application. Once filed, the application must be docketed for appropriate follow-up and in the normal course of exchange with the patent authority, including upon issuance of the patent, a variety of events must be docketed for consideration and action. Often this is done by mailing via postal service letters and documents for review and filing by the involved parties. The various parties often scan hard documents for “filing” in some document repository or file management system and the soft-copy documents may be communicated among the interested parties by email. After a patent issues, companies may license rights under the patent to others in exchange for payment of royalties or perhaps a cross-license of technology. There are many considerations associated with IP rights that need to be adequately tracked and monitored to enhance effective beneficial ownership of IP rights.

The management of IP rights across large concerns or across a multiplicity of concerns is made cumbersome by the localized nature of functions associated with the process. What is needed is a secure, integrated approach to handling the business process from ideation to maintenance and commercialization that promotes and facilitates informed decision making. What is needed is a flexible user intuitive workflow module capable of permitting users to create and modify workflow tasks and routines to tailor the user's approach to address particular business needs.

### SUMMARY OF THE INVENTION

The present invention provides an enhanced IP Workflow Manager (IPWM) that effects collaboration among users across a business organization that perform various business functions and that may be situated both inside and outside the organization and at various locations. The IPWM includes software to optimize, track and manage business processes related to product life cycle, including ideation of features or whole products and collecting and processing decisions respecting the identification, disclosure and securing of IP rights, including patent, trademark and copyright rights.

The IPWM may include an IP management services aspect, for example Thomson IP Management Services offered by Thomson Reuters Corporation, including IP Rules, IP Payments and Thomson IP Manager components, to handle intake and docketing of actions taken and to be taken in managing IP rights. The IPWM provides an effective way to receive, process, and store business data and to track and manage IP-related business processes and the commercialization of IP rights, such as through licensing of rights to third-parties. The IPWM may be implemented in a client/server architecture to establish communication links (wired, wireless, optical, etc.) to connect users over any, or any combination, of known networks, e.g., Internet, LAN WAN, private network, wireless network, public network, enterprise network, and VPN. The IPWM may be one or a combination of hosted and/or locally installed systems. Standard protocols, such as TCP/IP, HTTP, XML, etc., may be used. In addition to computing devices such as servers, notebook computers PCs, desktop computers, the IPWM may also communicate with user devices such as mobile phones, PDAs, etc. The IPWM may provide “push” communication of workflow events to the interested and/or affected user, e.g., a user that must respond to a date-sensitive request for instruction or action.

The IPWM provides a graphical user interface (GUI) adapted for various user experiences, such as for administration, legal, product management, inventor, and compliance functions. The IPWM may be used in conjunction with other business software and databases to provide a secure platform for user interaction and collaboration, such as through the assignment of roles and privileges based on each user's business function. The IPWM may be used to assist companies in determining advantageous assignment of ownership of IP rights across a plurality of entities to optimize tax and other considerations due to variations in tax rules of relevant jurisdictions, including allocation of revenues and costs associated with obtaining, maintaining and licensing IP rights.

The IPWM preferably includes workflows to handle the following strategic aims of the organization: promote innovation, develop and implement strategic IP portfolio, identify and select rights to protect, prepare/file IP related applications, maintain IP rights, commercialize IP, and enforce/assert IP rights. From the client perspective, a client or users access to the IPWM and associated data is determined based on an IPWM administrator function that defines access, roles and privileges, including the use of user groups, content groups, etc. An example of one essential IP workflow process is the invention disclosure submission, review, and filing decision process. IPWM workflow step types include: data entry, record management, data modification, form letters, and email messaging and includes global processes and service requests. The IPWM also allows for the use of nesting of workflow processes to more efficiently re-use processes.

The IPWM is adapted for integration within an overall computer-implemented system or enterprise to provide IP-specific workflow management tools while permitting ongoing IP management functions. While legal requirements may conform to standardized operations, organizations can vary greatly on internal processes and IP processes often vary are more specialized when compared to standard business processes. The IPWM provides a parallel management where a large organization can manage thousands of IP cases through slightly different processes at any given time. The IPWM provides a batch processing that allows individual case workflow to be intertwined with organizational processes, such as quarterly payment decisions, such as through integration with annuity management systems, and strategic reviews. The IPWM provides variability and flexibility by allowing IP processes to be handled with exceptions and optional pathways that otherwise make them difficult to model using conventional tools.

The IPWM provides a flexible workflow development and creation tool that allows users to create workflows to meet specific organizational needs and to marry with specific organizational systems and processes to provide an efficient and effective IP workflow system within an enterprise network. The IPWM provides an architecture that allows users to change processes easily and to expand processes with the addition of new steps, for example, within a standard IP workflow model. The user interface of the IPWM provides an enhanced user experience in visualizing, communicating, and enacting workflow processes.

In a first embodiment, the present invention provides a system for performing Intellectual Property (IP) management workflow processes. The system includes a central server comprising a processor for executing code, including a workflow program comprised of IP workflow routines executed by the central server and adapted to present via a graphical user interface workflow screens adapted to facilitate the exchange of data and instructions in executing IP workflow routines. The workflow program including an administration module adapted to create authorized user accounts and to assign roles and privileges associated with the created authorized user accounts involved in execution of IP workflow routines; a workflow creation module adapted to generate a user interface to facilitate creation of a user-defined IP workflow routine comprising first and second user-defined workflow tasks; a first user-defined workflow task adapted to process an IP related data set received via a user interface workflow screen; and a second user-defined workflow task and adapted to process a second data set representing a response to a review associated with the IP related data set. The system also includes a database adapted to store IP related data, including the IP related data set, the database being in communication with and adapted to exchange data with the central server. The first embodiment of the invention may also include the central server communicating with a first client computer having a user account operating thereon having an authorization established by the administration module. The invention may include a user interface workflow task screen comprising a workflow task type pulldown menu from which a user may select a desired workflow task type for creating a user-defined workflow task. A plurality of client computers are in communication with the central server and workflow screens generated by the IP workflow routines are selectively presented at the plurality of client computers based on the roles and privileges associated with the user accounts operating on the plurality of computers. The system may include an IP management application to access, process and modify IP related data stored at the database while the IP workflow routines access and process IP related data stored at the database simultaneously with execution of the IP management application. The workflow creation module may also include task modifiers associated with user-defined workflow tasks that further define workflow routine operation.

In a second embodiment, the invention provides a method for Intellectual Property (IP) management in a computer-based system having a central server executing IP workflow routines and being in communication with a database for storing IP related data, including IP case records. The method includes the steps of executing by the central server a user-defined IP workflow routine to generate user interface screens associated with first and second user-defined IP workflow tasks previously created by a workflow creation module, the generated user interface screens for display via client computers operating authorized user accounts; receiving by the central server a first IP related data set associated with execution of the first user-defined IP workflow task and in association with generation of a first user interface workflow screen; storing the first IP related data set at the database; executing by the central server the second user-defined IP workflow task and generating a second user interface workflow screen related to the execution of the second user-defined IP workflow task; and receiving and processing by the central server data received in response to the generated second user interface workflow screen. The method may also include selectively presenting user interface workflow task screens associated with the IP workflow routine at a plurality of client computers based on roles and privileges associated with authorized user accounts operating on the plurality of computers, this being further based on association of the authorized user accounts with the IP related data being processed by the IP workflow routine or associated with the user interface workflow task screens being presented. The invention may also include executing at the central server an IP rules module to generate IP related data based on a defined set of rules relating to rules governing the patent processes before patent authorities; executing an IP payments module to generate IP related data concerning IP related fees, due dates, and payment status; generating emails associated with the IP workflow routine; creating a user group comprised of authorized user accounts and executing at least one IP workflow routine to automatically communicate a workflow step to all user accounts comprising the user group; executing an IP management application adapted to access, process and modify IP related data stored at the database, and wherein the IP workflow routine accesses and processes IP related data stored at the database with simultaneous execution of the IP management application; executing a docket IP workflow routine on a predetermined basis to locate action items associated with IP related data and, based on an action code, directing subsets of the action items for further handling by other IP workflow routines; generating by execution of the docket IP workflow routine a workflow step comprised of a subset of action items and automatically communicating a workflow response form to a first user account assigned responsibility for the subset of action items; automatically generating by executing the docket IP workflow routine a message to a second user account assigned responsibility in the event no appropriate response associated with the first user account is received; executing an annuity payment IP workflow routine to query the database for data related to upcoming payment events and decisions, and generating a spreadsheet comprising query results and an email for communicating the spreadsheet to a user account or group of user accounts assigned responsibility for managing payment decisions; and executing the IP workflow routine to generate a request for IP related payment services.

In a third embodiment, the invention provides an Intellectual Property (IP) management workflow system for use in an enterprise network system comprised of client computers, server computers, and a database. The IP management workflow system includes: IP management software stored on computer readable memory and executed on a processor, the IP management software being adapted to communicate with a database having stored therein IP related data, including IP case records; IP workflow module including a graphical user interface (GUI) generator and adapted to enable an authorized user to create a first user-defined IP workflow routine comprised of first and second user-defined workflow tasks and to associate the first user-defined workflow task with a first user account and associate the second user-defined workflow task with a second user account; the IP workflow module adapted to generate a first GUI for presenting at a computer operating the first user account and being adapted to receive data associated with execution of the first user-defined IP workflow routine and to present via a GUI the first user-defined workflow task and to process a first input associated with the first user-defined workflow task; and the IP workflow module being adapted to generate a second GUI for presenting at a computer operating the second user account and being adapted to receive data associated with the first user-defined IP workflow routine and to present via a GUI the second user-defined workflow task and to process a second input associated with the second user-defined workflow task, wherein the first and second inputs represent data processed in performing the first user-defined IP workflow routine.

In a fourth embodiment, the invention provides a computer-based method for automating and managing workflow for data intake, retrieval, display, and decision management in performing Intellectual Property (IP) related workflow processes. The method includes the steps of: electronically receiving an invention disclosure submission associated with a first authorized user account and storing data related to the invention disclosure submission at a database; executing a first user-defined IP workflow routine comprising a first user-defined workflow task and generating a first workflow task screen prompting action from a second authorized user account relating to review of the invention disclosure submission; receiving for processing by the first IP workflow routine a first response relating to a filing decision concerning the invention disclosure submission and storing data related to the first response at the database; executing the first user-defined IP workflow routine to associate a third entity with the task of preparing and filing a patent application concerning the invention disclosure submission; and executing the first user-defined IP workflow routine to perform a docketing function associated with the invention disclosure submission. The method may further include the steps of: automatically executing a rules-based workflow task to determine target filing dates associated with the invention disclosure submission; processing by the first user-defined IP workflow routine a request for information relating to the invention disclosure submission and executing a second user-defined workflow task to present a workflow task screen comprising a prompt for information related to the invention disclosure submission at a computer operating an authorized user account other than the second authorized user account; and automatically generating by the first user-defined IP workflow routine an engagement letter associated with preparation of a patent application for sending to the third entity.

In a fifth embodiment, the invention provides a computer-based method for creating user-defined IP workflow routines in an Intellectual Property (IP) management system, the system including a central server executing IP workflow routines and a database for storing IP related data. The method includes the steps of: creating authorized user accounts and associating the created user accounts with roles and privileges involved in execution of IP workflow routines and processing IP related data stored at the database; executing by the central server a workflow creation module to generate user interface screens; and generating a signal adapted to be presented at a computer operating an authorized user account a plurality of workflow task creation screens and receiving inputs via the computer in response to the plurality of workflow task creation screens, whereby a user-defined IP workflow routine comprised of first and second user-defined IP workflow tasks is created. The method may also include the steps of: presenting via a user interface a workflow task type pulldown menu comprising a plurality of workflow task types from which to choose in creating a user-defined workflow task; and assigning a task modifier to a user-defined workflow task, the modifier determining in part the operation of the user-defined IP workflow routine. The task modifier directing the IP workflow routine to one of a plurality of workflow tasks based on a predefined event, e.g., timed advance; time expiration; alert condition; threshold number of responses; user delegation; default flow; alternate flow; conditional routing; and user response. The user-defined IP workflow task may be one of the group consisting of: action-level; portfolio-level; and case-level.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a schematic representation of an exemplary embodiment of a system architecture for interfacing and data transfer between an IP Workflow Manager (IPWM) and a plurality of client systems in accordance with the present invention.

FIG. 2 is a flow chart representing an exemplary business process associated with invention disclosure intake executed by the IPWM.

FIG. 3 is a schematic representation of the software architecture incorporating the IPWM component of the present invention.

FIG. 4 is a schematic diagram representing various user perspectives associated with using the IPWM in the context of an IP Manager system at the core.

FIG. 5 is a schematic diagram representing various user perspectives in the context of user and content (e.g., security) groups and how resources such as reports and workflows may be made available to users executing the IPWM.

FIG. 6 is a screen shot illustrating a data entry and rules processing form in conjunction with configuring the IPWM.

FIG. 7 is a workflow diagram illustrating an alternative rules process workflow associated with the IPWM.

FIG. 8 is a workflow diagram illustrating an exemplary New Invention Disclosure workflow associated with the IPWM.

FIG. 9 is a workflow diagram illustrating an alternative new invention disclosure submission and review workflow associated with the IPWM.

FIG. 10 is a workflow diagram illustrating an exemplary International Filing workflow associated with the IPWM.

FIG. 11 is a workflow diagram illustrating an exemplary Critical Action Review workflow associated with the IPWM.

FIG. 12 is a workflow diagram illustrating an exemplary Payment Decision: Large Corporate workflow associated with the IPWM.

FIG. 13 is a workflow diagram illustrating an exemplary Pre-Drop Review: Large Corporate workflow associated with the IPWM.

FIG. 14 is a workflow diagram illustrating an exemplary Secondary Filing Decision workflow associated with the IPWM.

FIG. 15 is a workflow diagram illustrating an exemplary Post-Acquisition Case Review workflow associated with the IPWM.

FIG. 16 is a workflow diagram illustrating an exemplary Daily Docket workflow associated with the IPWM.

FIG. 17 is a workflow diagram illustrating an exemplary Reminder Review workflow associated with the IPWM.

FIG. 18 is a workflow diagram illustrating an exemplary International Department Date Review workflow associated with the IPWM.

FIG. 19 is a workflow diagram illustrating an exemplary Critical Due Date Review workflow associated with the IPWM.

FIG. 20 is a workflow diagram illustrating an exemplary Non-Critical Due Date Review workflow associated with the IPWM.

FIG. 21 is a workflow diagram illustrating an exemplary QA Metrics Report workflow associated with the IPWM.

FIG. 22 is a workflow diagram illustrating an exemplary Final Payment Decision Report workflow associated with the IPWM.

FIG. 23 is a workflow diagram illustrating an exemplary Individual Daily Docket workflow associated with the IPWM.

FIG. 24 is a workflow diagram illustrating an exemplary Ad-Hoc Pay workflow associated with the IPWM.

FIG. 25 is a workflow diagram illustrating an exemplary Ad-Hoc Drop workflow associated with the IPWM.

FIG. 26 is a workflow diagram illustrating an exemplary Payment Discrepancy Management workflow associated with the IPWM.

FIG. 27 is a workflow diagram illustrating an exemplary payment upload workflow associated with the IPWM.

FIG. 28 is a workflow diagram illustrating an exemplary Status Download workflow associated with the IPWM.

FIG. 29 is a workflow diagram illustrating an exemplary Payment Review workflow associated with the IPWM.

FIG. 30 is a workflow diagram illustrating an exemplary License Review workflow associated with the IPWM.

FIG. 31 is a workflow diagram illustrating an exemplary Additional Services workflow associated with the IPWM.

FIG. 32 is a workflow diagram illustrating an exemplary Annuity Decision Review workflow associated with the IPWM.

FIG. 33 is a Workflow Creation Module exemplary screen shot and user interface associated with the workflow creation module of the IPWM.

FIG. 34 is a Workflow Task Creation—New Data Entry screen and user interface associated with the workflow creation module of the IPWM.

FIG. 35 is a Workflow Task Creation—Record Management screen and user interface associated with the workflow creation module of the IPWM.

FIG. 36 is a Workflow Navigation Panel or Collaboration Portal related workflow associated with the IPWM.

FIG. 37 is a Workflow Navigation Panel or Collaboration Portal related workflow associated with the IPWM.

FIG. 38 is a Workflow Task Submission screen—Workflow Query List (Task View) related workflow associated with the IPWM.

FIG. 39 is a Workflow Submission screen and user interface and Workflow Submission Task selected case popup window associated with the IPWM.

FIG. 40 is a Workflow Submission—New Data Entry screen and user interface associated with the IPWM.

FIG. 41 is a graphic representation of an “Investment—Expenses Per Technology” type Report associated with the IPWM.

### DETAILED DESCRIPTION OF THE INVENTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

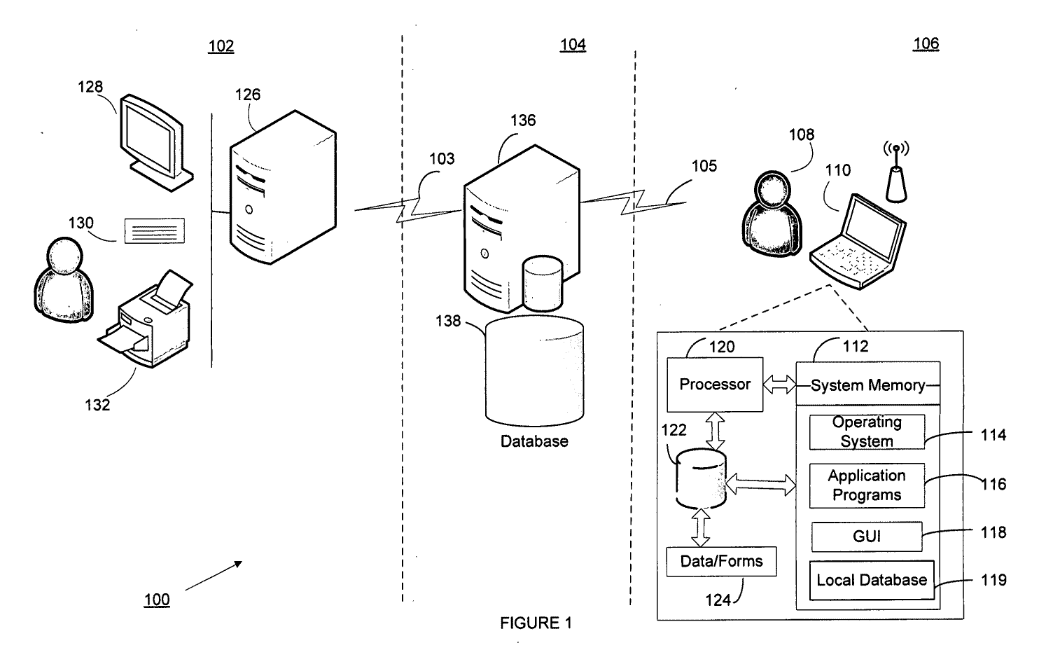

Referring now to FIG. 1, a client/server communication system 100 is shown for implementing the IP Workflow Manager (IPWM) and associated software that provides an effective bi-directional flow of business data and records to/from client systems 102 and 106 from centralized server 104, which may be co-located with some or all of the clients or remotely located from some or all of the client systems. The IPWM is preferably browser-based and may include one or more of application programs, example of which include client-side cookie, routine or applet, 116, available to or stored on the computer 110 at client 106, for example. The client systems 102 and 106 may be remote, may be within an organization or may be outside an organization, such as in the case of outside IP counsel. In this example, a user 108, such as an IP professional preparing a patent or trademark application, may access the IPWM operating at the central server 136 so as to receive workflow related instructions, updates, documents, etc., including data and forms stored at database 138. The users 102 and 106 establish communication links 103 and 105 with the central server system 104. This configuration is one of many and is not limiting as to the invention. Also, client 106 may use self-contained applications within a desktop or server or network environment and may utilize a local database 119, such as SQL 2005 or above or SQL Express or other suitable database, to store client data and records, which may then be uploaded to database 138 via communication link 105 or shared with users of the IPWM via email or the like. Any of several suitable communication links are available, such as one or a combination of wireless, LAN, WLAN, ISDN, X.25, DSL, and ATM type networks, for example. The communication link 103 is preferably secure such as by using encryption techniques. The client system computers may comprise a typical combination of hardware and software including, as shown in respect to computer 110, system memory 112, operating system 114, application programs 116, graphical user interface (GUI) 118, processor 120, and storage 122 which may contain electronic information 124 such as data records, transactions, data, procedures and the like. The operating system 114 should be suitable for use with the IPWM and browser functionality described herein, for example, Microsoft Windows Vista (business, enterprise and ultimate editions), or Windows XP Professional with SP2. Also, the IPWM and associated software may include custom integration with Adobe Acrobat applications, scanning software, and Microsoft Office applications, e.g., Outlook, Word and Excel. Application programs 116 may include, for example, Adobe Acrobat, Microsoft Office 2007, Office XP, or Office 2003. The system may require the client machines to be compatible with minimum threshold levels of processing capabilities, e.g., Intel Pentium III, speed, e.g., 500 MHz, and other parameters.

For purposes of discussion, an exemplary client system 102 may comprise a computer 126, user interface peripherals such as drives (not shown), monitor 128, keyboard 130, and printer 132. The client system computer and database 126 may be used to communicate remotely, such as via the Internet, with the IPWM central server system 104 and may load, pass, receive information, instructions and workflows, such as software executable on the machine 126 and data, forms, procedures and the like for storing and using locally by a user. A communication link 103 may be established between the client system 102 and the central server system 104 for updating data and software used by the user during execution of business processes.

The client system 102 may include a network of computers, such as over a LAN, WLAN, Ethernet, token ring, FDDI ring or other communications network infrastructure. The client facility may also include a database or other data storage component. Aspects of the system 100 may be enabled using any combination of Internet or (World Wide) WEB-based, desktop-based, or application WEB-enabled.

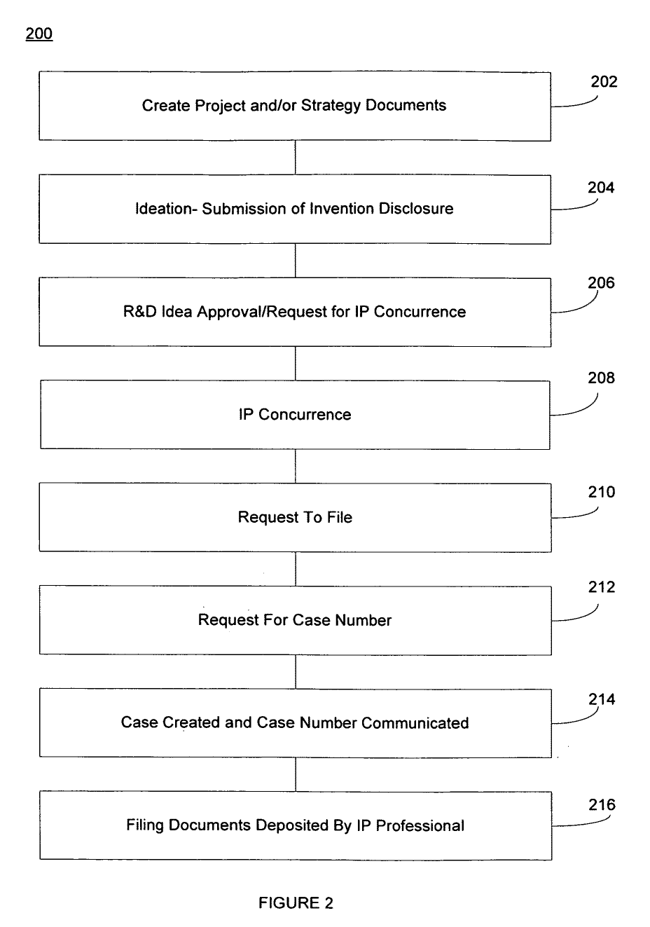

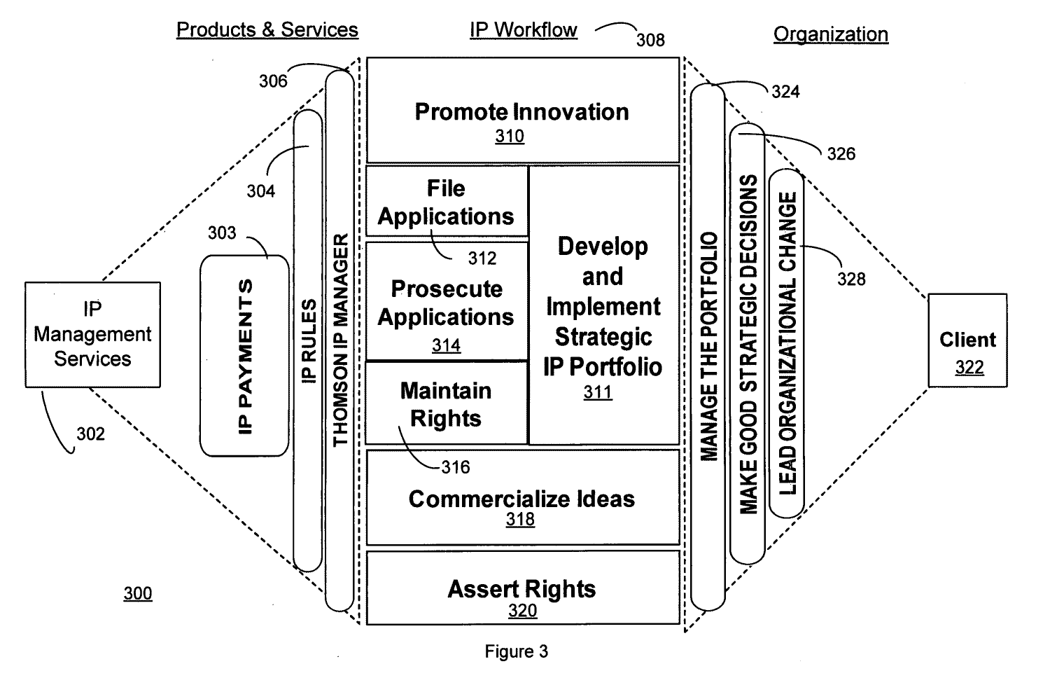

The flow chart 200 of FIG. 2 illustrates an exemplary embodiment of using the IPWM in the business process associated with product ideation and patent application decision-making and filing. At initial step 202, which is optional, an authorized user of the IPWM creates a project and/or strategy documents by using the IP Asset Manager. For example, a product manager assigned the task of overseeing a team of engineers in the development of a product may create a category or project, e.g., widget 9000—the name of the product project, anticipating that one or both of patentable inventions and viable trade names which to trademark will result from the effort, or some suitable internal code name for the project. In this manner the IPWM provides an electronic record in a centralized system that starts the process. At step 204, an inventor, or other authorized user, submits using the IPWM a disclosure which invokes a workflow process or routine to IP Manager, which disclosure may be further processed by the IP Manager 306 of FIG. 3. The workflow may include the requirement to associate the invention submission with existing project or strategy record created in step 202 and to create links between the Strategy record and other related documents.

At step 206, the R&D team or department or patent review committee, for example, reviews the submitted invention and may interact further with the inventor or the project leader. Upon approval of the submission, IP Asset Manager invokes a workflow, discussed in detail below, for IP concurrence to both trademark counsel (in the instance of parallel consideration of trademark issues) and patent counsel. In the case of a corporate legal department, the workflow may involve the Chief IP counsel receiving the request and initiating a workflow to either in-house or outside counsel or other legal staff to initiate the preparation of a patent search application or a trademark search or application. The responsible or associated IP counsel may be determined based on a previous association with the project, project record, business unit, category of invention, etc. This process may or may not use FTP/FTM (File Transfer Protocol/File Transfer Manager). Step 208 represents the IP Concurrence phase of this exemplary process and involves legal and business staff such as inside or outside patent and/or trademark counsel and/or product or brand managers who upon agreement the IPWM issues a reply to IP Manager and in the event of disagreement, the IPWM routes the workflow back to the IP counsel for review together to reach a joint agreement respecting the request. This step addresses the holistic IP concept where the invention is viewed for best coverage, e.g., design, utility, trademark, combination, etc. and strategic fit for the organization. The workflow process and related forms and communications should be designed with consideration given to the sensitive nature of legal advice and to take care to safeguard attorney/client and/or work product communications even within the organization.

At step 210, a user initiates a request to file instruction using IPW and a workflow to assigned IP professional and/or staff is invoked. At step 212, a Request for Case Number is initiated by the IP professional invoking a workflow to centralized filing group. The request includes information needed to create a record, including an IP asset manager's name and strategy document number. At step 214, a case is created and a case number is generated and communicated by centralized group and a workflow to IP professional and IP Manager is invoked. A record is created with a link to strategy document and information communicated includes unique record identifier. At step 216, filing documents are deposited by the IP professional. Documents stored either as attachment to Case Record or in a central repository that links by unique record identifier. In the alternative, users may deposit in case folders in central repository.

Referring now to FIG. 3, in this exemplary embodiment an overall business process related to IP management is shown generally referenced at 300 as including an IP management services aspect (IPMS) 302, the IPWM aspect 308 and the client organizational aspect 322. The IPMS 302 includes an IP rules component 303, an IP payment component 304, and an IP manager component 306 to handle intake and docketing of actions taken and to be taken in managing IP rights. Examples of components that perform similar functions are the Thomson IP Management Services offerings of Thomson Reuters Corporation. The IPWM provides workflow functionality to integrate with the separate functions of the IPMS, such as provided by a law firm or as provided by the organization legal department, with the organizational decision making and management functions as represented by organization aspect 322.

The IPWM aspect 308 provides an effective way to receive, process, and store business data and to track and manage IP-related business processes and the commercialization of IP rights, such as through licensing of rights to third-parties. As described in the context of FIG. 1 above, the IPWM may be implemented in a client/server architecture to establish communication links (wired, wireless, optical, etc.) to connect users over any, or any combination, of known networks, e.g., Internet, LAN WAN, private network, wireless network, public network, enterprise network, and VPN. Standard protocols, such as TCP/IP, HTTP, XML, etc., may be used. In addition to computing devices such as servers, notebook computers PCs, desktop computers, the IPWM may also communicate with user devices such as mobile phones, PDAs, etc. The IPWM provides “push” communication of workflow events to the interested and/or affected user, e.g., a user that must respond to a date-sensitive request for instruction or action.

The IPWM 308 provides a graphical user interface (GUI) adapted for various user experiences, such as for administration, legal, product management, inventor, and compliance functions. The IPWM may be used in conjunction with other business software and databases to provide a secure platform for user interaction and collaboration, such as through the assignment of roles and privileges based on each user's business function. The IPWM may be used to assist companies in determining advantageous assignment of ownership of IP rights across a plurality of entities to optimize tax and other considerations due to variations in tax rules of relevant jurisdictions, including allocation of revenues and costs associated with obtaining, maintaining and licensing IP rights.

The IPWM 308 preferably includes IP workflow routines, and a workflow creation module that enables users to create workflow tasks and routines, to handle the following strategic aims of the organization: promote innovation 310, develop and implement strategic IP portfolio 311, identify and select rights to protect 312, prepare/file IP-related applications 314, maintain IP rights 316, commercialize IP 318, and enforce/assert IP rights 320. From the client perspective 322, a client or users access to the IPWM and associated data is determined based on an IPWM administrator function 328 that defines access, roles and privileges, including the use of user groups, content groups, etc. The business function of strategic decision making is referenced at 326 with specific reference to management of IP portfolio within the organization at 324.

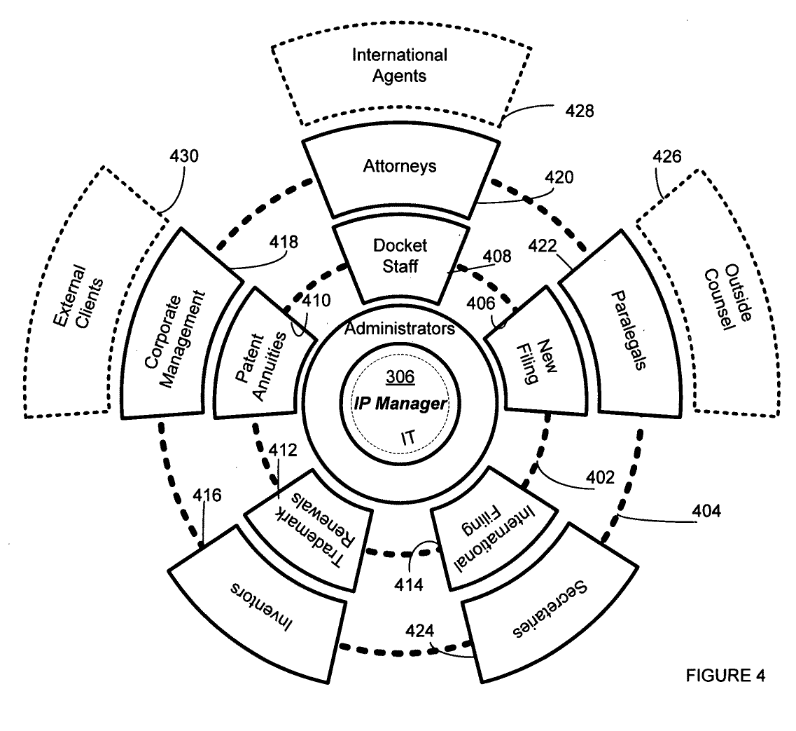

Referring to FIG. 4, overall business process associated with IP rights management are shown with IP Manager 306 at the core as supported by an organization's IT staff. Administrators oversee the use of IP Manager and the access of users as well as roles, privileges, etc. Aspects of the overall IP management include new patent filings 406, docketing 408, annuities, 410, trademark renewals 412, and International filings 414. Those participants in the IPWM to carry out the IP management include inventors 416, corporate management 418, attorneys 420, paralegals 422, secretaries 424, outside counsel 426, international agents 428, and external clients 430.

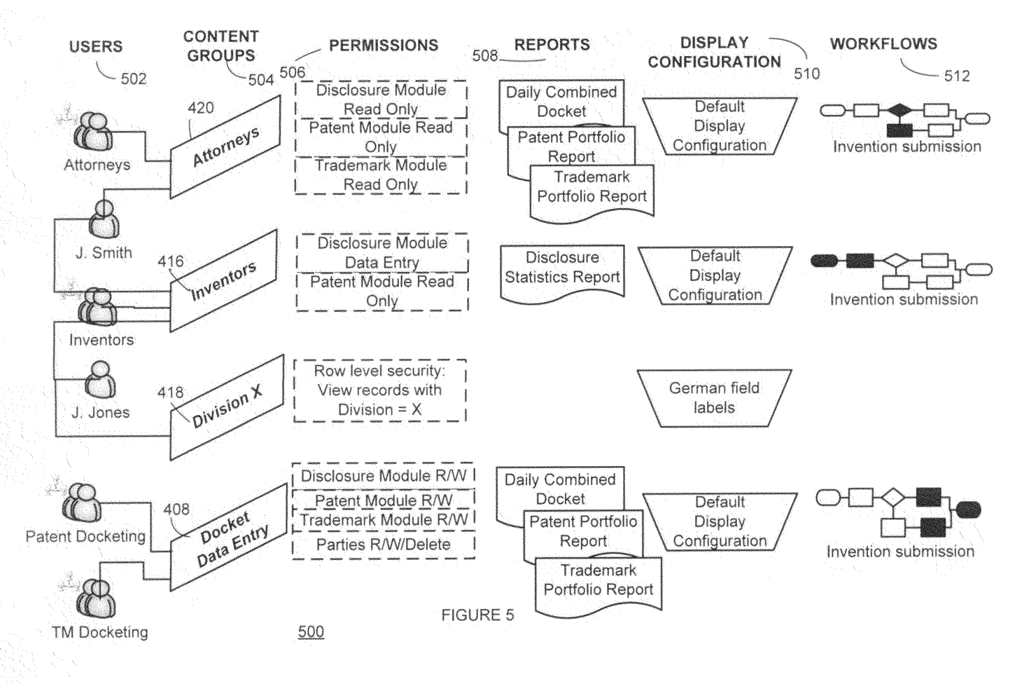

Referring now to FIG. 5, a more detailed expression of the categorization of users, roles, responsibilities, etc. is shown with exemplary set of IPWM users 502 and content groups 504 as including attorneys 420, inventors 426, corporate division management 418, and docket function 408. Exemplary Permissions 506, reports 508 display configurations 510 and workflows 512 are shown.

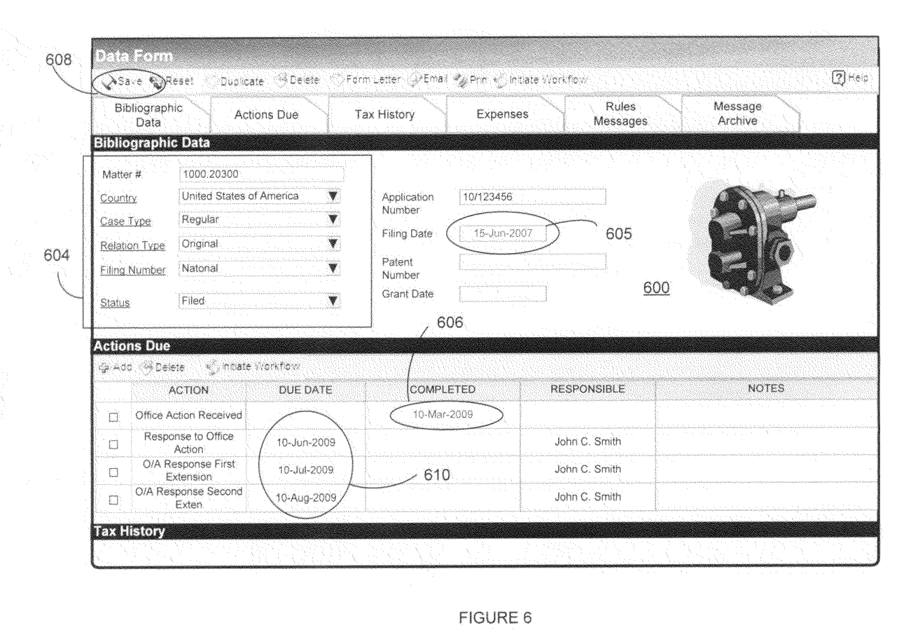

Referring now to FIG. 6, a screen shot 600 illustrates a GUI to allow a user to input data entry relating to a case record, in this instance data associated with U.S. patent application Ser. No. 10/123,456. In this example, in the bibliographic data area a user selects from pulldown menus in section 604 the appropriate characteristics of the record, which may have been otherwise automatically pre-selected, in order to process the entered data with the appropriate rules. The pulldown menus of section 604 represent rule types that define the set of rules calculations relevant to the application record. In this example, at 605 the user enters a filing data, 15 Jun. 2007, associated with the application and at 606 enters a date, 10 Mar. 2009, associated with an Office Action Received action, e.g., the mailing date of an office action received during the prosecution of the application. At 608 the user may click on the “Save” button to initiate rules processing of the entered data and selected rule types. At 610, the rules module or aspect of the IPMS processes rules based on the selections at 604, i.e., response dates are generated by rules according to rule type, and the information entered at 606 to generate and populate fields under “Due Date.” In this example the rules engine or module generated a “Response to Office Action” date of 10 Jun. 2009 as well as dates for first and second extensions for the response.

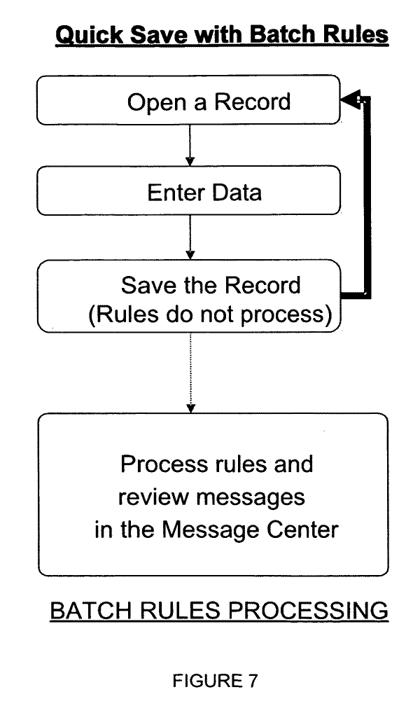

FIG. 7 is a schematic diagram illustrating a batch rules process associated with the IPMS as an alternative way of saving data in records. In particular, time is saved by permitting a user to input data in multiple records and saving the data in those records prior to processing the rules and reviewing messages received in the message center. The data entry or record management is the feature within the workflow that form is performing and provides functionality that effectively lets users work across all cases at a workflow step for any step type.

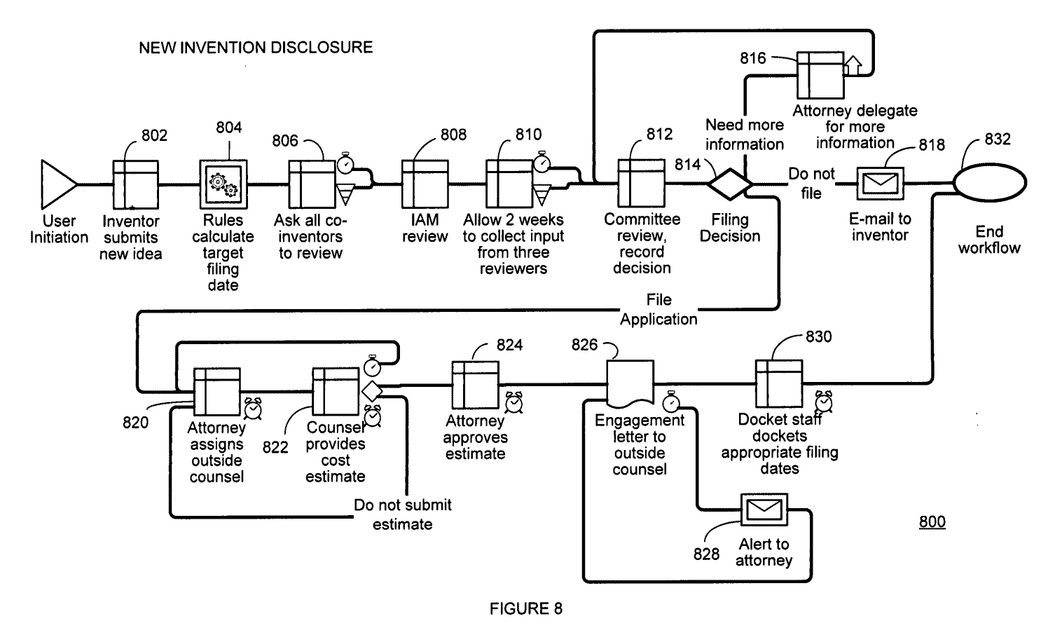

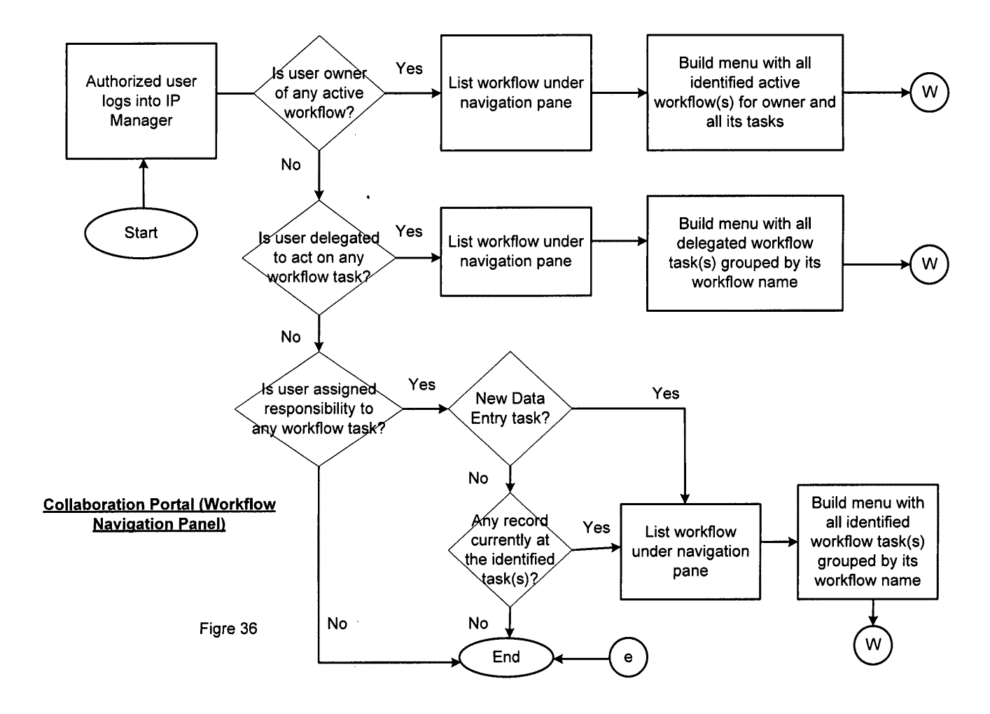

FIG. 8 is a workflow diagram illustrating the New Invention Disclosure workflow 800 associated with the IPWM and that may be created by a user using the workflow creation module to create discrete workflow tasks 802-832, that comprise the workflow routine 800. At step 802, the form of which as illustrated refers generally to viewing and managing records and presenting a data entry form to the user, a user, such as an inventor, having authorized access to the IPWM submits a new idea or disclosure. Based on the information provided by the inventor, at step 804, the form of which represents background rules processes which may run without human intervention, a rules process is performed in the workflow to calculate a target filing date. For instance, if the information submitted by the inventor indicates a disclosure of the invention on a certain date, then the workflow will automatically perform a rule calculation that establishes a target date of, for instance, something less than the one-year potential bar date of the disclosure. At step 806, which is shown with workflow step modifiers of a timed advance and a threshold that requires that a set number of users respond before advancing to the next step, all inventors receive from the IPWM a workflow requesting review of the submission. The timed advance of step 806 represents that the workflow will escalate to a different step if a set time limit expires, refer to the task modifier description below related to FIG. 35. At step 808, the IP Asset Management (IAM) review step directs workflow to reviewers of the submission. At step 810, the reviewers are allowed two weeks to input review information and a threshold number of reviewers must respond by that time. At step 812, a workflow is presented to a decision making committee, which reviews and records its decision respecting the invention. As represented at decision step 814, the committee decides 1) not to file on the submission and that ultimately leads to the end of the workflow at 832; 2) that it needs more information and forwards to an attorney delegate at step 816; or 3) elects to file an application and the workflow proceeds to step 820. The conditional or alternate flow associated with the decision step 814 is described further below in relation to the task creation and task modifier discussion related to FIG. 35. The decision to file an application may also include a workflow step of electing the type of application to be filed, e.g., US design patent application, US provisional patent application, US utility patent application, PCT application, or a non-US application. At step 820, and attorney assigns the matter to outside counsel for filing a patent application within a set time or to at least provide the attorney with a cost estimate for preparing the application. As indicated by the alarm clock graphic, the workflow will send an alert to the user that the workflow step requires attention. At step 822, in this embodiment the assigned attorney provides a cost estimate within a certain time, which if fails an alert is sent to a user and the workflow advances to the next step. At step 824, an attorney approves the submitted estimate and at step 826 an engagement letter is sent to outside counsel. At step 830, the docket staff dockets the appropriate filing dates and that is the end of this workflow process.

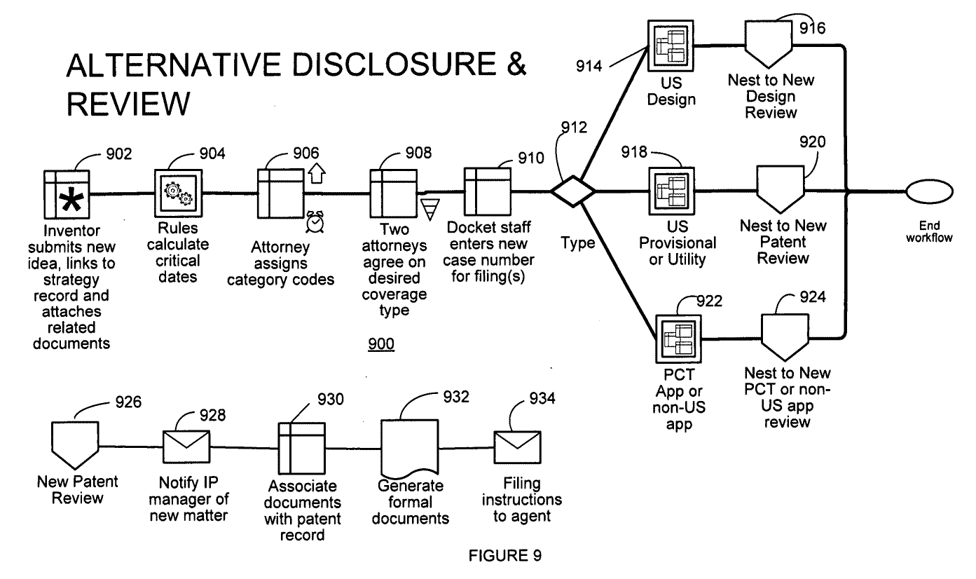

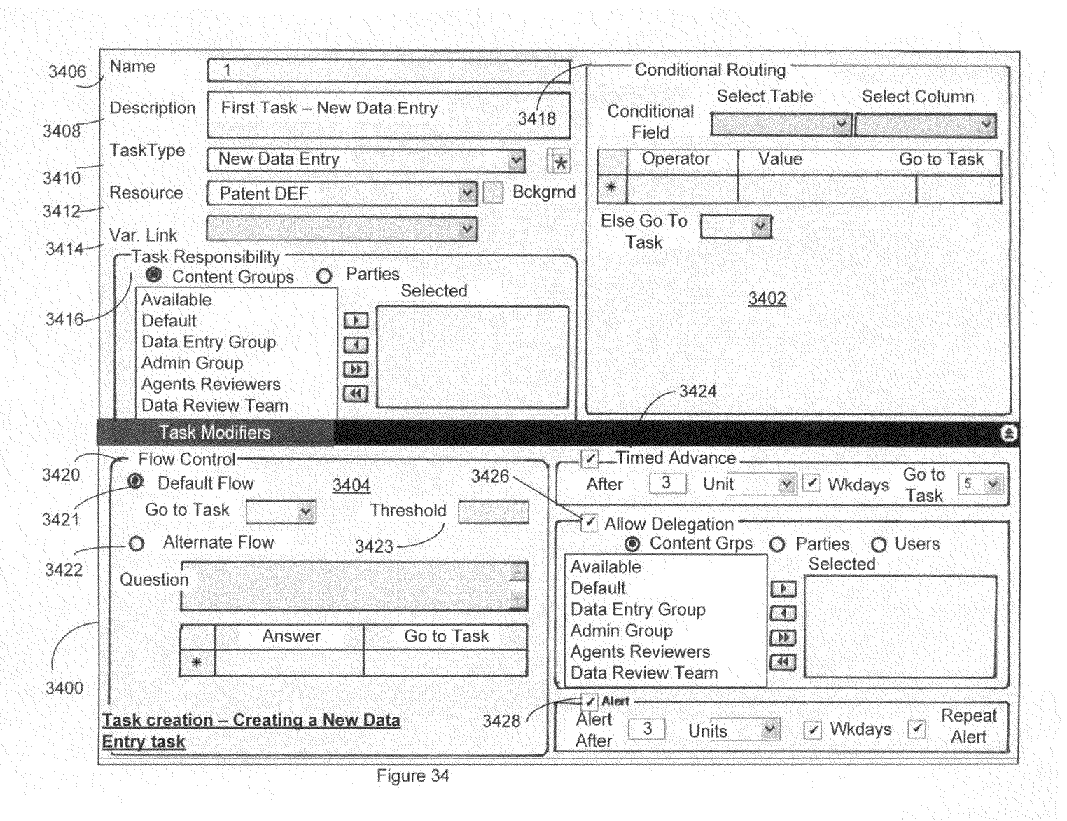

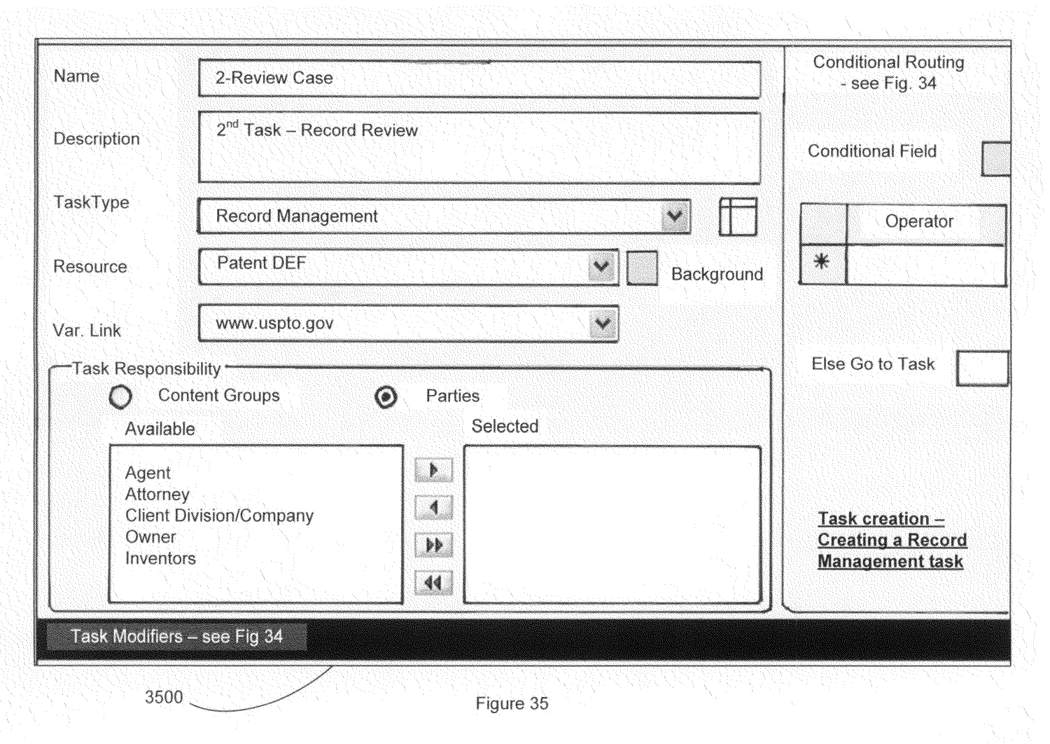

FIG. 9 is a workflow diagram illustrating an alternative new invention disclosure submission and review workflow process associated with the IPWM. At step 902 the user, e.g., inventor, submits an invention disclosure and links to the strategy record, provided one has previously been established, and attaches related documents, such as an invention disclosure or write-up or invention disclosure form. At step 904 a rules step performs a calculation to determine suggested critical dates, such as a “file-by” date. At step 906 an attorney assigns a category code(s) such as technology related to the invention. At step 908 the task is assigned to an “attorneys” pool, from which two attorneys must provide input that agrees upon coverage type for the invention. The threshold modifier described in FIG. 34 is used to require input from more than one user within a user pool or Content Group. At step 910 docket staff is presented with a workflow task for entering a new case number for one or more filings. Step 912 represents a workflow step associated with the decision as to the type of coverage to pursue. At step 914 the workflow duplicates relevant fields from the initial disclosure record into a new US Design patent application record according to a pre-defined template, and the new patent record is passed to another workflow comprising the steps for reviewing new US design applications via step 916. If the decision is made to pursue a US provisional (or utility) application a workflow step 918 duplicates relevant fields from the initial disclosure record into a new US provisional patent application record according to a pre-defined template, and the new patent application record is passed to another workflow comprising the steps for reviewing new US provisional applications via step 920. If the decision is made to pursue a PCT (or non-US) application, then step 922 duplicates relevant fields from the initial disclosure record into a new PCT patent application record according to a pre-defined template, and the new patent application record is passed to another workflow comprising the steps for reviewing new PCT applications via step 924. In this example, steps 916, 920, and 924 are nested type steps. The nested new patent review step 926 results in an email being presented to a user for review, edit and sending to notify an IP manager (individual) of the new matter. This may be automatically generated and sent as well. At step 930 a user is presented with a workflow task to associate documents with the newly created patent record. Workflow step 932 is presented to a user for generating formal documents and at step 934 a user is presented with an email step to review, edit, and send an email with filing instructions to an agent. A form letter step could be used in place of the email step 934, for example.

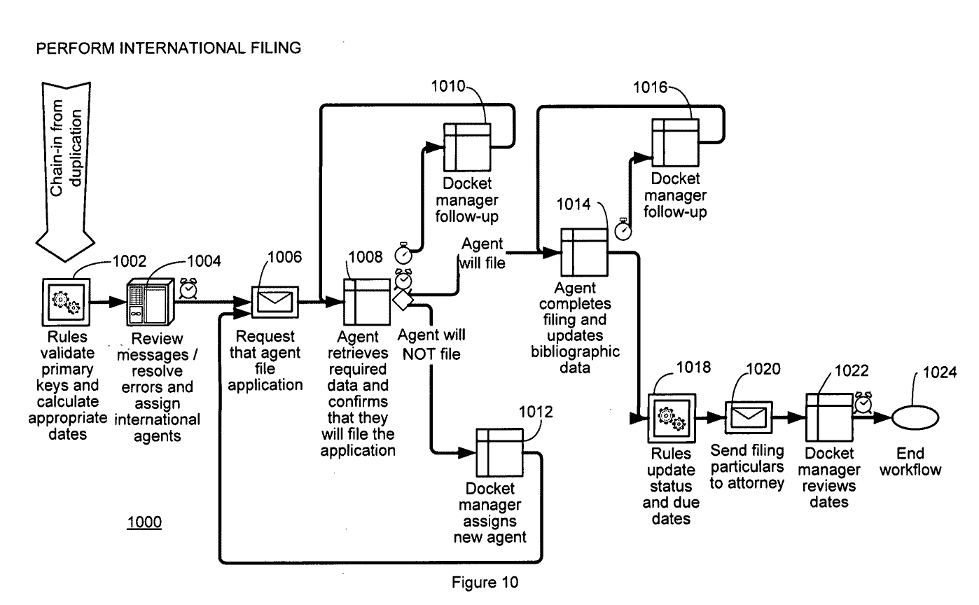

FIG. 10 is a workflow diagram illustrating an exemplary International Filing workflow 1000 associated with the IPWM. At step 1002, a nested workflow in which a case is sent to the selected workflow, 1000, for processing. Here a case selected for international filing consideration is processed and rules are run to validate primary keys and calculate appropriate dates. At step 1004 the process includes a workflow to user(s) for reviewing messages and resolving any errors and assigning international agents to the case. The step 1004 as shown is a “data entry” type workflow that presents a user with a list of all records and the user performs data entry on each one of the presented records and advances records either individually or as a group. At step 1006 an email is presented to the used to edit and send to request that the agent file an application. At step 1008, the agent retrieves the required data and confirms whether they will file the application. If the agent does not file the application, at step 1012 a step to notify the docket manager to assign a new agent. If the agent will file the international application then the workflow proceeds to step 1014 and the agent completes filing and updates bibliographic data record. At step 1010, the task has been escalated to a docket manager based on the timed event threshold of step 1008. A similar follow-up workflow for the docket manager is provided at step 1016 concerning step 1014. At step 1018, the case record is processed through the rules engine to update status and due dates associated with the case. At step 1020 a user is presented with an email to review, edit and send to attorney regarding filing particulars. At step 1022 the docket manager reviews the dates and the workflow ends at step 1024.

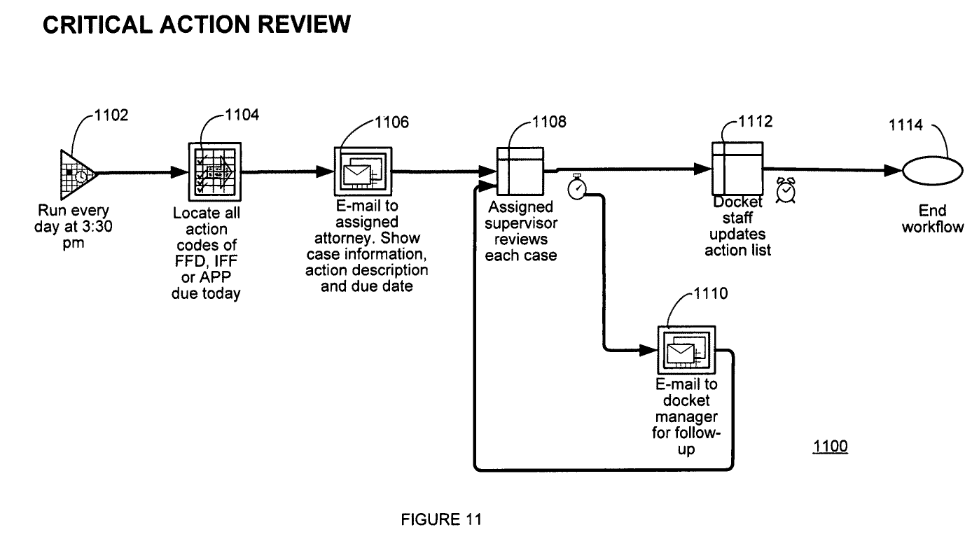

FIG. 11 is a workflow diagram illustrating an exemplary Critical Action Review workflow 1100 associated with the IPWM. At step 1102 the IPWM automatically runs a process against the database of case records, for instance at 3:30 pm, and at step 1104 locates all action codes of FFD (foreign filing deadline), IIF (issue fee due) or APP (file application) due on that day. At step 1106, in this instance a background task, an email is automatically sent to the assigned attorney showing case information, action description and due date. At step 1108 an assigned supervisor reviews each case and based upon a timed threshold an email may be presented at step 1110 to docket manager as a follow-up to ensure completion of action. Tasks may be assigned to individuals or to groups comprised of a plurality of individuals. Tasks may be assigned based on the role or responsibilities assigned to the users, individually or by group, and may be assigned on a case by case basis, e.g., user assigned responsibility to a particular case. The task may be assigned, for example, to the “Supervisor” as defined in the individual case while allowing anyone in the Supervisors group access to the task. Only the supervisor assigned to the particular case will see it in their workflow portal. At step 1112 a docket staff user updates the action list with a timed event and the workflow ends at step 1114.

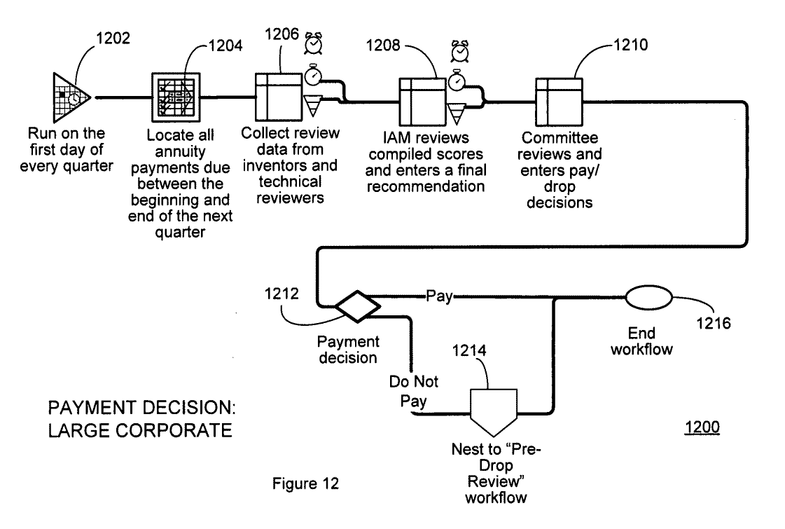

FIG. 12 is a workflow diagram illustrating an exemplary Payment Decision: Large Corporate workflow 1200 associated with the IPWM. At step 1202 the IPWM runs a process on the first day of each quarter, for instance, and at step 1204 the IPWM locates all annuity payments due between the beginning and the end of the next quarter, using date calculation functions that dynamically calculate the date range based on the run date of the workflow. For instance, using the automatic date calculation function the system may take a representation such as “start of this quarter” or “first day of the third quarter” and, based on an understanding of the representation, dynamically calculate a workflow date or date range. At step 1106 a user is presented with a workflow to collect review data from inventors and technical reviewers. At step 1208 the IAM reviews complied scores and enters a final recommendation. At step 1210 the committee reviews and enters pay/drop decisions, reflected in the decision tree output 1212. If the decision is not to pay the annuity, then a nested “Pre-Drop Review” workflow queues the decision for action and the workflow ends at step 1214. If the decision is to pay the annuity then that decision is recorded and the workflow ends.

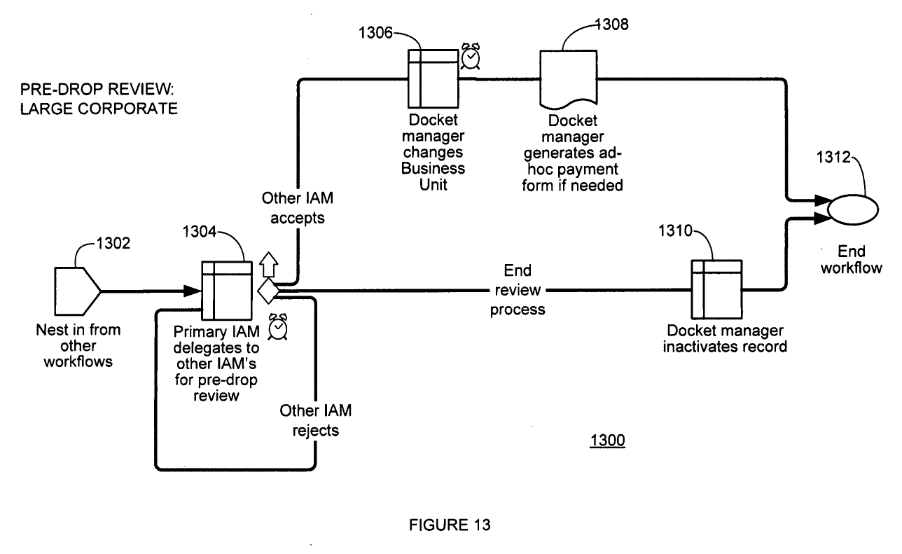

FIG. 13 is a workflow diagram illustrating an exemplary Pre-Drop Review: Large Corporate workflow 1300 associated with the IPWM. At step 1302 the event is initiated as a nest-in from other workflows and is acted upon at step 1304 where the primary IAM has the option to delegate to other IAMs for pre-drop review. Delegation is accomplished through the Delegation modifier discussed in FIG. 35. If the other IAMs reject then the decision is routed back to the primary IAM via step 1304. At the end of the review process the workflow ends. If the other IAMs accept the decision, then the docket manager at step 1306 is presented with a workflow to change Business Unit to align with the instructions of the accepting IAM and at step 1308 generates an ad-hoc payment form if needed and the workflow ends. At step 1306, if the docket manager does not execute the step within a predefined time frame, the docket manager will begin to receive e-mail alerts as defined in the timed alert modifier.

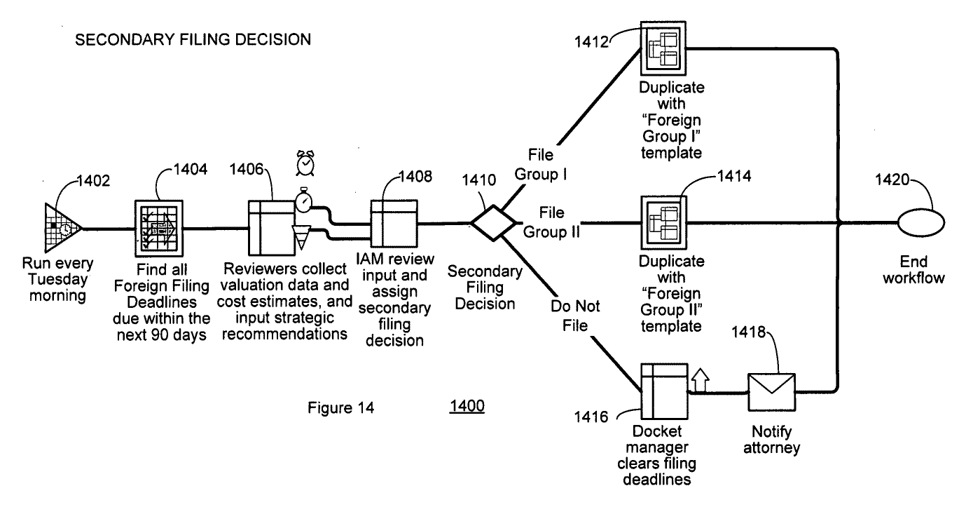

FIG. 14 is a workflow diagram illustrating an exemplary Secondary Filing Decision workflow 1400 associated with the IPWM. At step 1402 the IPWM runs a process every Tuesday morning, in this example, and at step 1404 finds all foreign filing deadlines due within the next ninety days. Duplicates of cases already in the workflow are automatically ignored. At step 1406 reviewers are presented with a workflow to collect valuation data and cost estimates and input strategic recommendations with consideration for this as a timed threshold type event as previously described. Step 1410 represents the decisions to: 1) file in “group I” countries, which proceeds to step 1412 to duplicate the parent application record into a series of child application records using the “Foreign Group I” pre-defined template; 2) file in “group II” countries, which proceeds to step 1414 to duplicate the parent application into a series of child application records using the “Foreign Group II” pre-defined template; and 3) do not file, which invokes a workflow to docket manager 1416 to clear filing deadlines and to, at step 1418, present the docket manager with an email to review, edit and send to notify the attorney of the decision and action. Duplication templates automatically chain the newly created child filing records to “Perform International Filing” workflow of FIG. 10. At the end of the decision process the workflow ends.

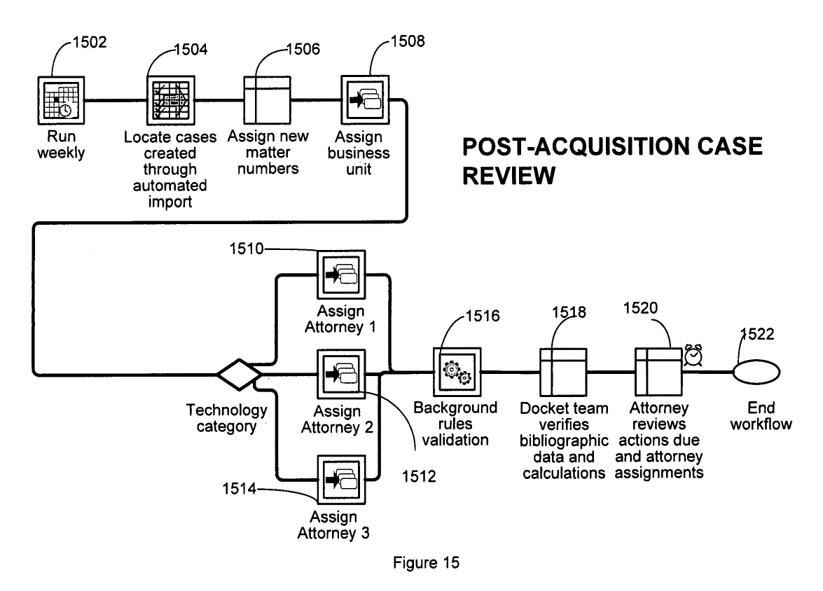

FIG. 15 is a workflow diagram illustrating an exemplary Post-Acquisition Case Review workflow 1500 associated with the IPWM. At step 1502 the IPWM runs a weekly process and at step 1504 locates cases created through an automated import function. At step 1506 the user is presented with a “data entry” type workflow step to assign new matter numbers to the cases created and at step 1508 the system performs an automated change of data within the case record based on pre-defined settings. In this case changing the business units associated with the case record. Step 1510 reflects a technology category process whereby attorneys associated with a particular business unit or category are automatically assigned to the cases created. This is reflected in steps 1512-1516 assignment of attorneys 1, 2 and 3, who will receive workflows associated with the assignment and which may respectively appear on each attorney's individualized dashboard, discussed below. At step 1516 the IPWM performs background rules validation and at step 1518 the docket team is presented with workflow to verify bibliographic data and calculations. At step 1520 the attorneys are presented with workflows to review actions due and respective assignments, which is a timed event resulting in email notification if the time period ends without user response or action. The newly acquired cases, which may be created by acquisition as well as other events, may be added to the database through DTS or other back-end processes.

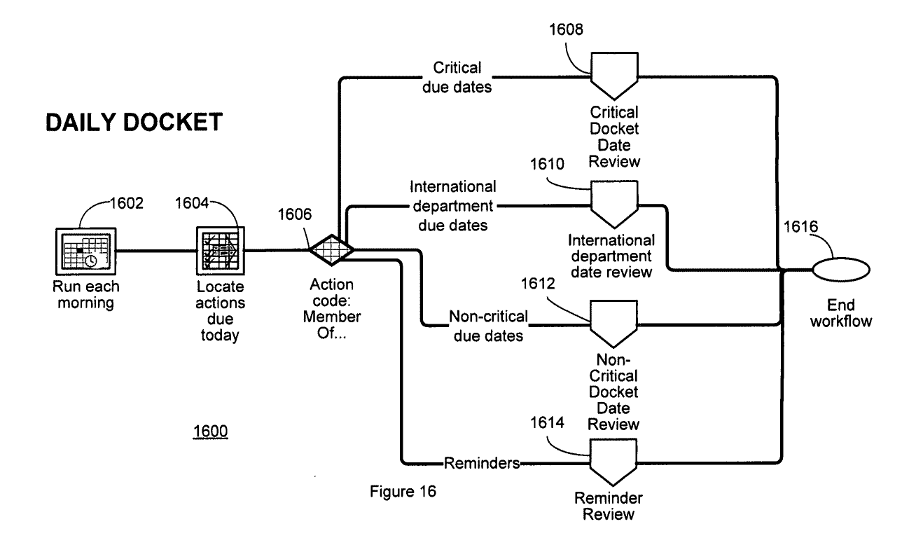

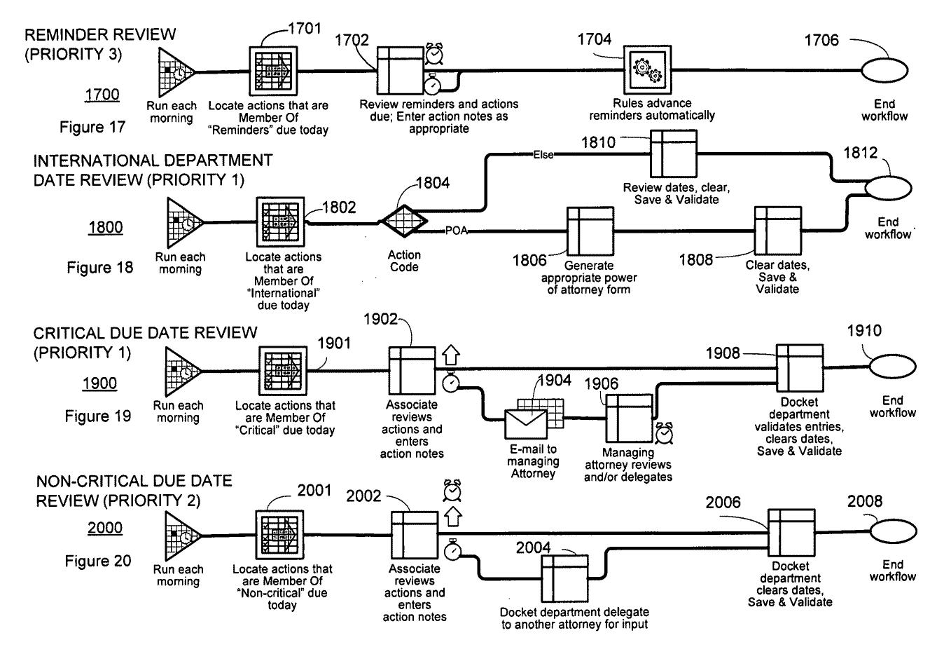

FIG. 16 is a workflow diagram illustrating an exemplary Docket workflow 1600 associated with the IPWM. At step 1602 the IPWM runs a process each morning, for instance, and at step 1604 locates actions due on that day. Step 1606 represents a an action-level conditional routing as follows: 1) critical due dates are nested into the Critical Docket Date Review workflow 1900 at step 1608; 2) nested into the International Department Date Review workflow 1800 at step 1610; 3) nested into the Non-Critical Docket Date Review workflow 2000 at step 1612; and 4) nested into the Reminder Review workflow 1700 at step 1614. This may be accomplished by use of a child-table with automatic routing based on the child table value passed to the workflow. Refer to FIGS. 17-20 below. Note that “actions” represent due dates related to the internal processing or external collaboration with counsel or respective patent offices. Actions are preferably associated with the “master” case record as related foreign tables within the database. Action-level workflows cause master records to be added to workflows (as shown in step 1604) and allow decisions to be made based on values in related foreign tables, such as the Actions table, as shown in step 1606 above.

FIGS. 17-20 are exemplary action-level workflows related to daily (or periodic) docket review processes to identify and communicate reminders related to due dates coming due, for instance that day, that week, that month, or that quarter or that year. The reminder workflows may be routed to individuals responsible for taking some action or supervising the accomplishment of related tasks. FIG. 17 is a workflow diagram illustrating the Reminder Review action-level workflow 1700 associated with the IPWM. Upon the process being initiated, such as automatically on a daily basis, at step 1702 a “query into workflow” type workflow step, which involves automatically inserting matching records or data into the workflow, is presented to the user to review reminders and actions due and to enter action notes as appropriate. At step 1704 a rule is performed and reminder advance automatically.

FIG. 18 is a workflow diagram illustrating an exemplary International Department Date Review action-level workflow 1800 associated with the IPWM. Upon the process being initiated, such as automatically on a daily basis, at step 1802, a query into workflow type step, the workflow locates actions that are categorized as “International”, or requiring response from an international department, due today. At step 1804 the workflow follows one of two paths and users are presented with workflow screens based on action code. If the action due requires a Power of Attorney, for example, a power of attorney POA form workflow step is generated and processed at step 1806 after which a user is presented at step 1808 with a screen to review the action due, clear, save and validate the record. Otherwise at step 1810 the user receives a workflow to review dates and clear, save and validate the review action.

FIG. 19 is a workflow diagram illustrating an exemplary Critical Due Date Review action-level workflow 1900 associated with the IPWM. Upon the process being initiated, such as automatically on a daily basis, at step 1901, a query into workflow type step, the workflow locates actions that are members of “critical” due today. At step 1902 an assigned associate is presented with a workflow to review actions and enter action notes. This is a timed workflow. If the period for action expires, then the IPWM presents an email to the managing attorney at step 1904 and with a workflow to review and/or delegate the matter for review and action. At step 1908, the docket department is presented with a workflow to validate entries, clear dates, save, and validate record.

FIG. 20 is a workflow diagram illustrating an exemplary Non-Critical Due Date Review action-level workflow 2000 associated with the IPWM. Upon the process being initiated, such as automatically on a daily basis, at step 2001, a query into workflow type step, the workflow locates actions that are members of “non-critical” due today. At step 2002 an assigned associate is presented with a workflow to review actions and enter action notes. This is a timed workflow. If the period for action expires, then the IPWM presents a workflow to the docket department at step 2004 to delegate the matter for review and action to another attorney for input. At step 2006, the docket department is presented with a workflow to clear dates, save, and validate record.

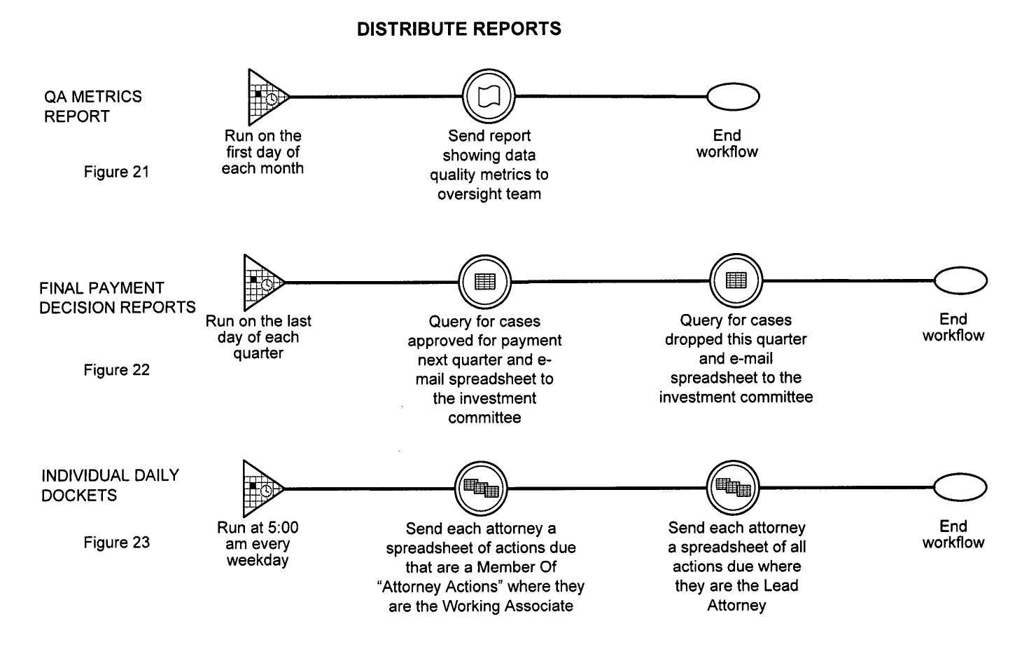

FIGS. 21-23 illustrate examples of portfolio-level workflows related to distributing reports among participants. Portfolio-level workflows comprise reporting and data transfer tasks that may reach across the entire database to produce output that may be case-specific, as in a due date report, or may contain summary data, as in a chart of expenditures by business unit. FIG. 21 is a workflow diagram illustrating the QA Metrics Report workflow that may be run on the first day of every month and that sends reports, such as a pre-defined portfolio report converted to pdf form, showing data quality metrics to an oversight team. FIG. 22 is a workflow diagram illustrating the Final Payment Decision Report portfolio-level workflow that may be run on the last day of each quarter and that queries database for cases approved for payment the next quarter. An email may issue to distribute a spreadsheet, such as Excel, to an investment committee or other assigned group or individual. A further query for cases dropped in that quarter is run and an email distributing a spreadsheet having this information is sent to the investment committee. FIG. 23 is a workflow diagram illustrating the Individual Daily Docket portfolio-level workflow which may be run every weekday. The IPWM respectively sends an email with attached spreadsheet, or other form of reporting, to assigned attorney showing actions due. This may be performed by sending the report to an “Attorney Actions” member where the attorney is an assigned working attorney and the report includes due dates associated with cases assigned to that working attorney or associate. An additional report or spreadsheet may be generated and sent to assigned “Lead Attorneys” involved in overseeing the case.

In addition to action-level and portfolio-level workflow routines, there are case-level or matter-level workflow routines that involve creation, modification and routing of master records, which are standard matter records that are the primary record related to a filing for an IP matter, e.g., all bibliographic data, children record data, etc. In one exemplary manner of implementation, a primary table vs. foreign table type database structure may be used.

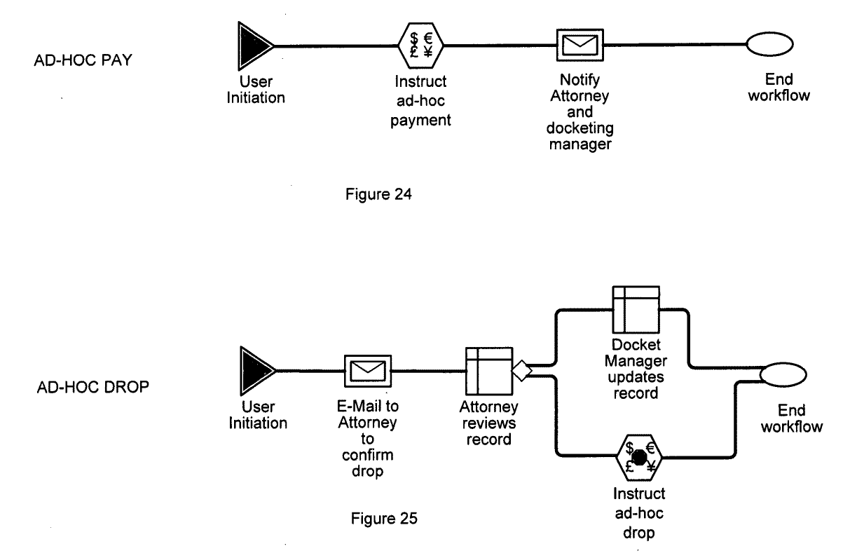

FIGS. 24 and 25 relate to an exemplary ad-hoc process of changing decisions or for otherwise making ad-hoc payments for or drops of cases and transmitting those decisions to a payment services provider, such as IP Payments by Thomson IP Management Services. FIG. 24 is a workflow diagram illustrating the Ad-Hoc Pay workflow in which a user initiates the workflow and is presented with a workflow to instruct IP Management Services of the ad-hoc decision to pay the case. A user is presented with an email to review, edit and send to an attorney to notify the assigned attorney(s) and docket manager of the ad-hoc decision to make payment. FIG. 25 is a workflow diagram illustrating the Ad-Hoc Drop workflow in which a user initiates the workflow and is presented with an email to review, edit and send to an attorney to confirm decision for a case. The attorney is presented with a workflow to review the record and provide input on the decision. A docket manager updates the record based on the attorney input and for an ad-hoc decision to drop the case, a workflow is generated to instruct IP Management Services of the decision to drop the case.

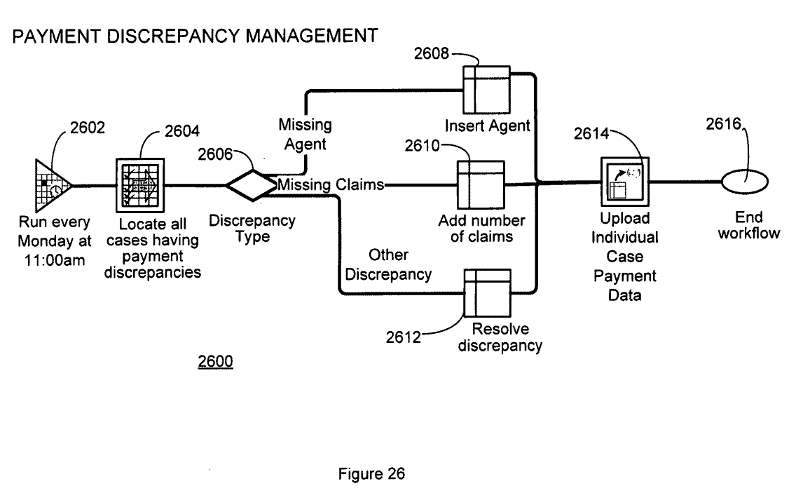

FIG. 26 is a workflow diagram illustrating an exemplary Payment Discrepancy Management workflow 2600 associated with the IPWM. Payment discrepancies arise when information sent to the payment services provider does not match official records at the patent office. Payment discrepancies must be resolved quickly to ensure timely payment of maintenance fees, annuities or renewals. At step 2602 the IPWM runs a process every Monday, for example, and at step 2604 locates all cases having payment discrepancies. Step 2606 represents respective paths for handling different types of discrepancies, including: 1) missing local agent information, which at step 2608 a user is presented with a data entry type workflow to insert an agent; 2) missing claims, which at step 2610 a user is presented with a data entry type workflow to add number of claims; and 3) other discrepancies, which at step 2612 a user is presented with a generic data entry workflow to resolve the discrepancy. As each discrepancy is resolved or corrected, at step 2614 a background process uploads individual case payment data to the payment services provider.

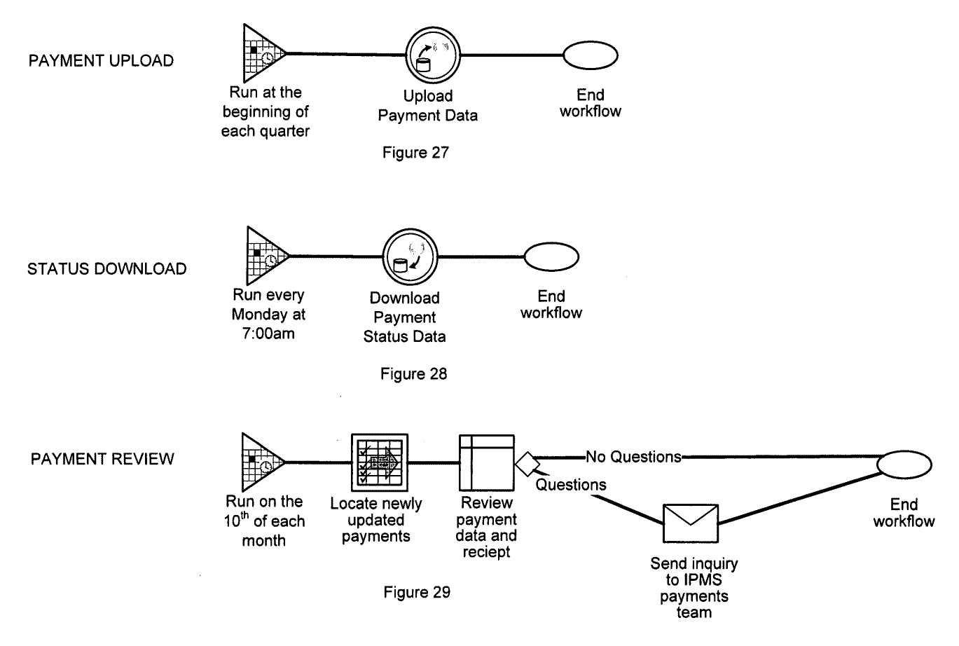

FIGS. 27-29 relate to exemplary workflows for handling scheduled payment, e.g., through a payment services provider. The IPWM may have scheduled timed batch rules to update and review before upload. FIG. 27 is a workflow diagram illustrating the payment upload portfolio-level workflow which is run at the beginning of each quarter to upload payment data. FIG. 28 is a workflow diagram illustrating the Status Download portfolio-level workflow and is run every Monday, for example, for downloading status data associated with scheduled payments. FIG. 29 is a workflow diagram illustrating the Payment Review workflow and is run monthly, e.g., the 10^{th} of each month, and includes workflows to locate newly updated payments and a workflow for reviewing payment data and receipt. If the user has questions, then the user is presented with an email to review, edit and send to the payment services vendor, for example. Otherwise the workflow ends.

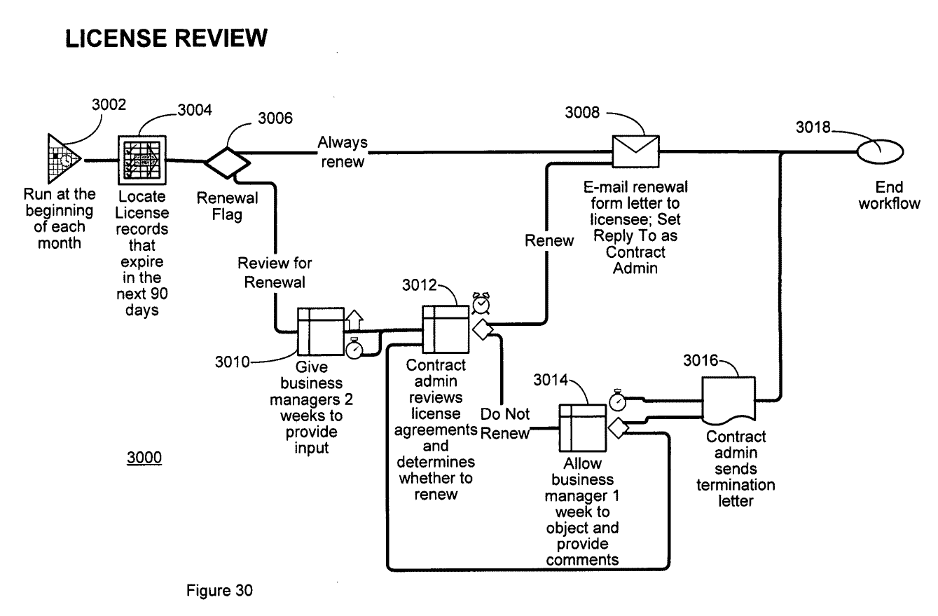

FIG. 30 is a workflow diagram illustrating an exemplary License Review workflow 3000 associated with the IPWM. At step 3002 the IPWM runs at the beginning of each month a process where at step 3004 locates license records that expire within a set time period, e.g., within following ninety days. Workflow step 3006 is a Conditional Routing step, which routes the case to different workflow paths depending on information within the case record. If the “Renewal Flag” field is set to “Always Renew”, the user is presented with an email at step 3008 to review, edit and send, along with a letter or form, to the associated licensee. A reply to the email may be set, for example, to an attorney or to a contract administrator. If the “Renewal Flag” field is set to “Review for Renewal”, then at step 3010 a workflow is invoked to business managers giving them a workflow with a deadline for responding to the review in which to provide input. At step 3012, the contract administrator is presented with a workflow step to review the license agreements and determine whether to renew. At this step, the User-Decision modifier is used to provide the user with a pop-up dialog box asking a question with multiple possible answers. If the decision is to renew, then the workflow proceeds to step 3008. If the decision is not to renew, then the workflow proceeds to step 3014 and the business managers are allowed a set time period, e.g., one week, in which to respond via the workflow to object and provide comments regarding renewal. If the decision remains to not renew the license, then the contract administrator is presented with a workflow and form letter, such as a filled in Word letter, to edit, print and send terminating the license. If the business manager does not respond within the set time period, the Timed Advance modifier automatically advances the case to step 3016.

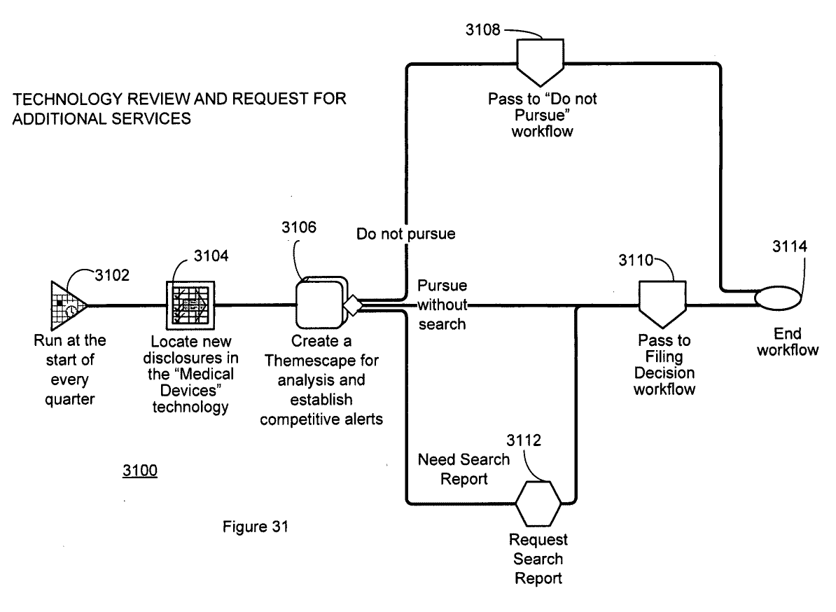

FIG. 31 is a workflow diagram illustrating an exemplary Additional Services workflow 3100 associated with the IPWM. At step 3102 the IPWM runs a process at the beginning of each quarter, for example, and at step 3104 locates new disclosures in a certain category, previously established as discussed above, for example “Medical Devices” technology. At step 3106 an application may be invoked to create a value-added means to evaluate technology, for example, using the Thomson Innovation solution provided by Thomson Reuters Corporation, to create a Themescape for analysis and to establish competitive alerts. The User-Decision modifier is applied to this step, allowing the user to decide how cases should be routed, including: 1) do not pursue invoking the solution; 2) pursue without search, and 3) pursue with search report. The user interface for the task allows the user to make choices and advance cases individually, or as a group. At step 3108 a nested workflow passes on the decision to not pursue the matter. At step 3110 a nested workflow passes to the Filing Decision workflow. At step 3112, a request for search report is generated and transmitted to a professional service provider, such as the IP Consulting services of Thomson Reuters and the matter is passed to step 3110. The technique of “nesting” workflows is optional but may be used to re-use functional workflow steps to add efficiency to the overall system.

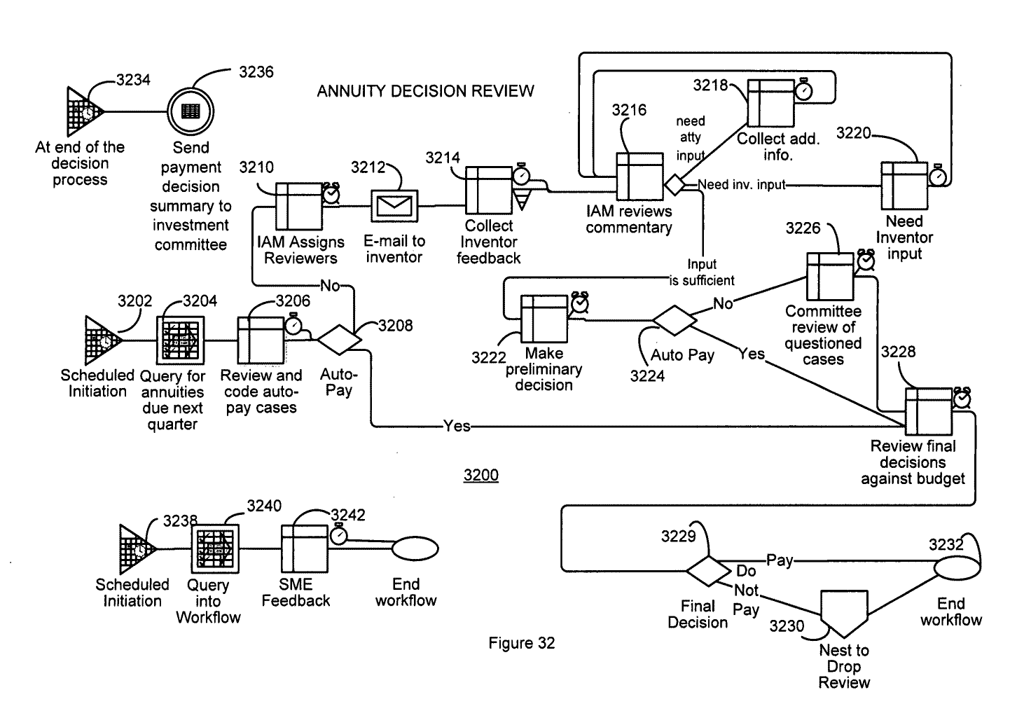

FIG. 32 is a workflow diagram illustrating an exemplary Annuity Decision Review workflow 3200 associated with the IPWM. At step 3202, a scheduled initiation is commenced and at step 3204 the IPWM runs a query for annuities due in the next quarter or some other time period. At step 3206 a data entry workflow is presented to a user to review and code auto-pay cases. Conditional routing step 3208 routes cases depending on the value assigned to the AutoPay field within the case record. At step 3210 IAM is presented with a timed workflow to assign reviewers and is presented with an email to send to inventors for comment, which is returned to IAM via step 3214, which is also a timed advance and threshold modified workflow step, for input. At step 3216 IAM is presented with an alternate or conditional flow type workflow screen which presents the user with a question the response to which directs the routine to one of steps 3218, 3220 or 3222. If the decision is made to collect additional information from either or both of attorneys assigned to the case or from inventors, then workflows associated with steps 3218 and 3220 commence. If the decision is that there is no need for additional information then the process proceeds to step 3222 at which the IAM is presented with a timed workflow to make preliminary decision regarding payment. If the decision is to proceed with auto-pay then the process proceeds to step 3228. Otherwise at step 3226 a committee may be presented with a workflow to review the questioned cases. At step 3228, the user or user group is presented with a timed workflow to review final decision against budget—this may be done individually or collectively. The decision may then be directed to a nested workflow for processing in the Need to Drop Review workflow. A separate portfolio-level workflow may be scheduled to run after the decision-making cycle has ended, as shown at 3234, and run a pre-defined query and convert the results to include in an excel spreadsheet or the like for email to designated recipients, for example a payment decision summary delivered to an investment committee.

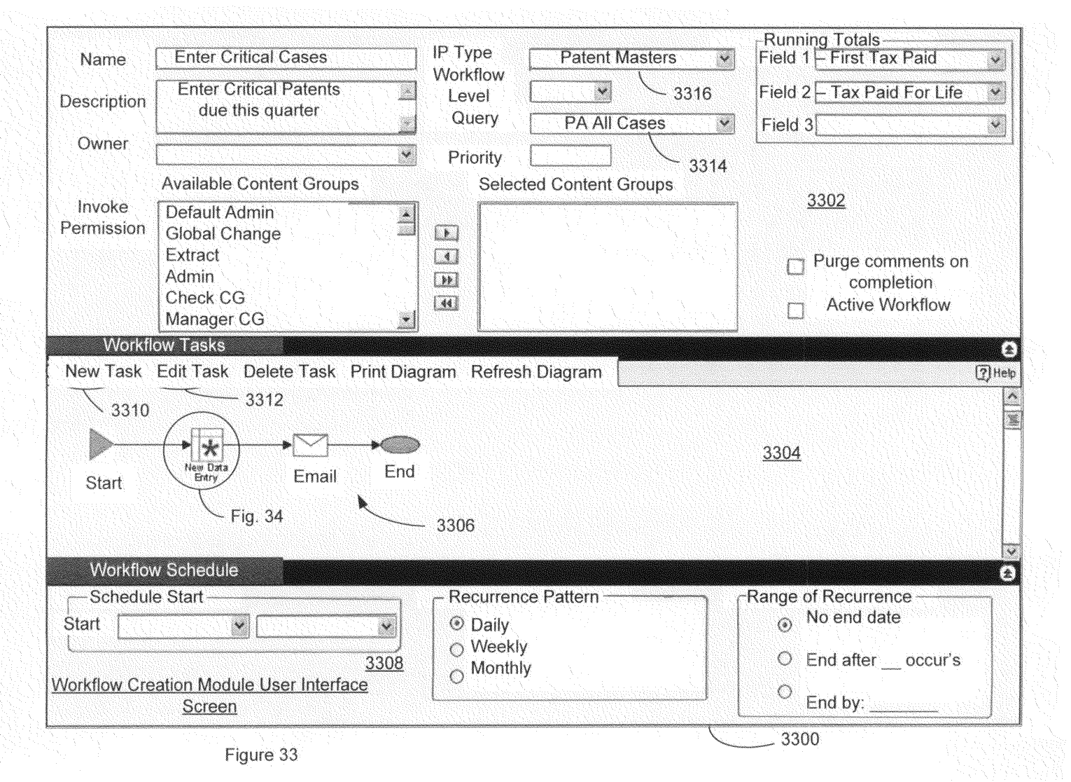

With reference to FIGS. 33-35, the following description further defines functionality and features associated with exemplary embodiments of the workflow creation module of the IPWM. In particular, the following description relates to an adaptive system that allows users to create workflow tasks and routines that may be integrated with an IPMS. The user may configure the workflow routines and tasks to tailor the workflows to a particular implementation, such as in defining how a particular entity or company desires to formulate its workflows to meet its particular goals and needs. In this description, certain terms may be used. Workflow definition refers to basic workflow details that are required to create a workflow. Workflow Task definition refers to basic workflow task details that are required to create a task within a workflow. Shell Task refers to an empty task created as a result of the <Add Task> 3312 menu bar option in the Task Details popup user interface 3300 of FIG. 33. Once the shell task is defined fully and saved it becomes a regular task. Matter-level refers to workflow processes and emails that may be created as case-based by assigning them as matter-level. In such cases, a specific case record with all its action records and other child table records will be executed against this process or Email resource. Action-level refers to workflow processes and emails that may be created as Action-based by assigning them as Action-level. In such cases, a specific action record within a case will be executed against this process or email resource. Action-level workflows are a special case of more general child table-level workflows that may work on any child table values associated with the master case record, such as expenses, tax dates, document associations, trademark classes & goods, etc. Portfolio-level refers to workflows and emails that may select and act upon data across the entire system, without necessarily being associated with individual case records.

The invention provides a workflow or process architect system to enable users to implement an improved user interface. The workflow creation module or process designer aspect of the invention provides an improved user interface by giving users the ability to create processes, IP workflow tasks and routines, in popup windows for integration with IPMS software, e.g., Thomson IP Manager solution from Thomson Reuters. The workflow user interface provides a view of all tasks (steps) in one screen with the ability to manage each task in separate popup windows providing users with the latest available resources for task creation. The improved user interface opens up the workflow creation module functionality in pop-ups and displays the overall flow of tasks to enable users to continue using IPMS services while creating a workflow or process. The workflow creation module provides users with the ability to view all tasks in one screen and also manage individual tasks with the latest resources available.

Now with reference to FIG. 33, the workflow creation module presents an exemplary workflow creation module popup user interface screen illustrated and referenced as 3300. The screen 3300 includes, in the area generally referenced 3302, management controls, e.g., process name, process description, process owner, IP type, Collaboration Level—Matter, Portfolio, Action, Query format, Process priority, running totals (maximum of 3 selections), invoke permission settings (by one or more content groups), option to “Purge comments” after process completes, and an option to activate a process. The screen 3300 also includes in the area referenced 3304, a collapsible tasks pane (including menu bar options—<New Task> 3310, <Edit Task> 3312, <Delete Task>, <Print Diagram> <Refresh Diagram>, <Help>), and workflow diagram or process blueprint 3406 showing all existing tasks. In the event the user clicks on the “Edit Task” button, then an existing and at least partially completed task detail workflow screen, such as the New Data Entry task detail screen of FIG. 34, will be presented for editing by the user. At the area referenced 3308, the user interface screen includes a collapsible scheduled initiation pane (including controls: schedule start, recurrence pattern, and range of recurrence). The collaboration level may default to “Matter.” When an authorized user navigates to the workflow creation module popup and clicks the Query Format dropdown 3314, the system lists the latest available queries for the selected IP Type 3316. The selected query will be employed in the Task View screen to list the records in a task. Query Format is an optional selection. Task View screen is explained in detail below. When an authorized user navigates to the workflow creation module popup and makes a Query Format selection, the system populates the three running total dropdown controls with displayed fields from the selected query. The “Running Total” fields may default to blank when a selection is made for Query Format 3314. Running Total fields dropdown (Field 1, Field 2 and Field 3) must be cleared for an empty Query Format selection. Authorized users may select up to three running total fields by selecting the required query in the Query Format and the required fields from the three Running Total fields. The columns selected for Running total will be summed and displayed below the results section in the Workflow Query screen.

In the event a user clicks on the “New Task button 3310 in area 3304, the user interface presents a Workflow Task Details window with blank fields (unshown) as a user interface for task creation and maintenance. It includes the following controls to define: Task Name, Description, Task Type, Icon corresponding to the selected task type, Resource, Variable Link (disabled by default), Task assignment to Content groups/Parties and the Available and Selected lists, Conditional Routing controls (disabled by default), and Task Modifiers (Default Flow and Alternate Flow, Threshold, Timed Advance, Alerts, Allow Delegate) (not shown). Shell Task icon may be displayed as the default task type icon, .i.e., when no task type is selected.

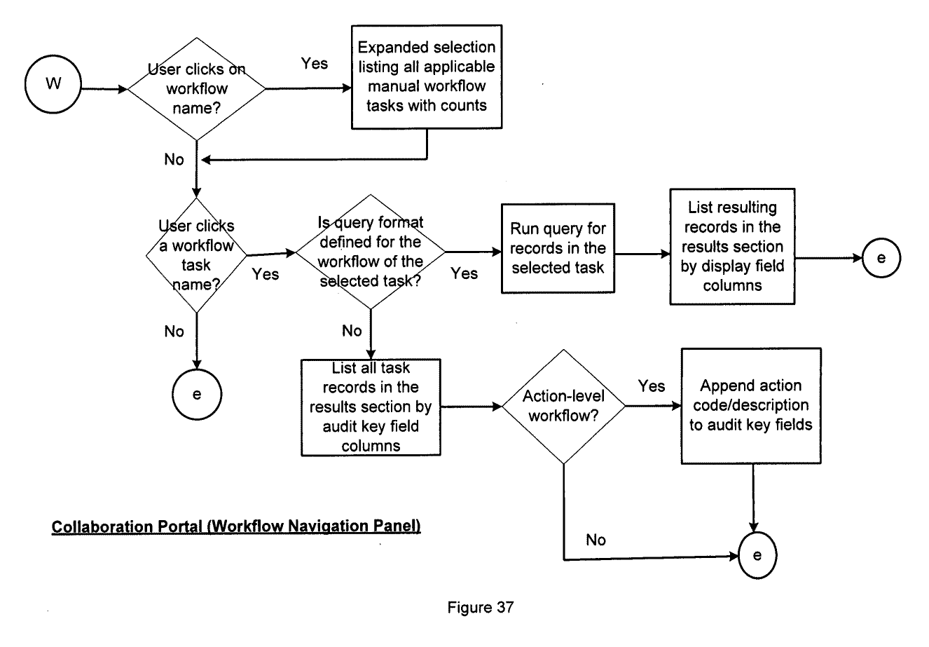

The workflow creation module includes additional features to enable users to create prioritized processes, duplicate processes and designate processes to clear comments after completion. Based on the process design, active processes may be listed in prioritized order and comments may be purged from the case record's collaboration history once the case record completes a collaboration cycle. In this manner, users may collaborate according to process priority and purge comments after completion of a process to align with the client's data retention policies. This enables users to duplicate an entire process with all its tasks. Modules that may be used in implementing this include Workflow Maintenance, Workflow implementation, Workflow History (Record management). When a user clicks on the workflow collaboration portal from the navigation pane, the system expands the pane to list existing and applicable Active processes in the following manner, e.g., any prioritized processes ordered by their assigned priority in ascending, and alphabetic listing of any available un-prioritized processes. Active processes defined with the same priority may be listed alphabetically under the Collaboration Portal navigation. Refer to FIGS. 36-37.

Now with reference to FIG. 34, associated with operation of the workflow creation module, a Workflow Task Detail screen for New Data Entry, 3400, is shown as an example of data entry type tasks, which includes New Data Entry, and Record Management. For instance, a user from the screen of FIG. 33 may select the “New Data Entry” workflow task shown on the blueprint 3306 and click on the “Edit Task” button 3312. Workflow task creation screen 3400 includes a task detail section 3402 and a task modifier section 3404. Task detail section 3402 includes the following fields or field groups: task name 3406, task description 3408, task type 3410, resource 3412, variable link 3414, task responsibility (with content group and parties options) 3416, and conditional routing section 3418. Task modifier section 3404 includes flow control section 3420 with options for default flow 3421 and alternate flow 3422 having an associated question and answer fields. A user creating an IP routine identifies the first workflow task and then may assign a default flow to the next workflow task by selecting from a pull-down menu at the “Go to task” option of 3421 and may assign a threshold, e.g., number of responses, required to advance to the next task or step. For example, the task 3214 of FIG. 32 was defined with a threshold modifier 3423, as well as a timed advance modifier 3424, that requires a set number of inventor feedback responses as a threshold before satisfying the task. The user may assign an alternate flow via 3422 and input a question to ask the user presented with the task flow. The user creating the IP workflow routine then identifies answers to the question and assigns “Go to tasks” that determine the alternate flow path of the routine. For instance the alternate flow task at step 3216 of FIG. 32 in which the IAM reviews commentary and then is presented with a question as to which of the alternative flow paths to follow, i.e., collect additional information step 3218, need inventor input 3220, or make preliminary payment decision 3224. The IAM user may be presented with a pull-down menu of available answers, as defined by the user creating the task, and then, based on the answer selected, the task automatically advances to the task associated with the answer. Task modifier section 3404 also includes the following task modifiers: timed advance 3424, delegation 3426, and alert 3428. Steps or tasks 3218 and 3220 of FIG. 32 are also examples of tasks that were defined with the timed advance modifier 3424, which includes a defined number of units (e.g., days, weeks, months) after which to advance to the selected “Go to task.” Task 3222 of FIG. 32 is an example of a task defined with the alert modifier 3428, which involves presenting an alert after a set number of units, e.g., days, weeks, months, and which may be repeated. Task 3010 of FIG. 30 is an example of a task defined with a delegation modifier 3426, which may delegate the task to further action based on an assigned content group or parties or users. In the example of task 3010, the task with delegation modifier is further modified by a timed advance modifier whereby business managers are given two weeks to provide input via the user interface screen presented to them. If no action is taken by the assigned business managers within the two weeks, then the task automatically flows to delegated users for action. In operation, tasks accumulate in a consolidated email digest and a user accesses his account and is presented with the accumulated tasks for completing. Tasks that sit in the user email box unattended beyond the time period set in the timed advance modifier automatically escalate and, for example, cause the IPWM to generate and send an email to a designated user for attention to the task. New Data Entry and Record Management may be handled as two distinct tasks. New Data Entry task, if available, is the starting task of the process. This enables users to segregate the creation of a new record as part of a process from other data modification tasks. The user interface indicates which processes a user can initiate from a Collaboration Portal screen. When an authorized user selects “Record Management” as task type in the Task Type popup, the system enables the Variable Link dropdown for user entry and populates the control with available variable hyperlinks defined for the IP Type selected in the corresponding Workflow creation module popup. FIG. 35 illustrates a Workflow Task Detail screen 3500 for creating a Record Management task.

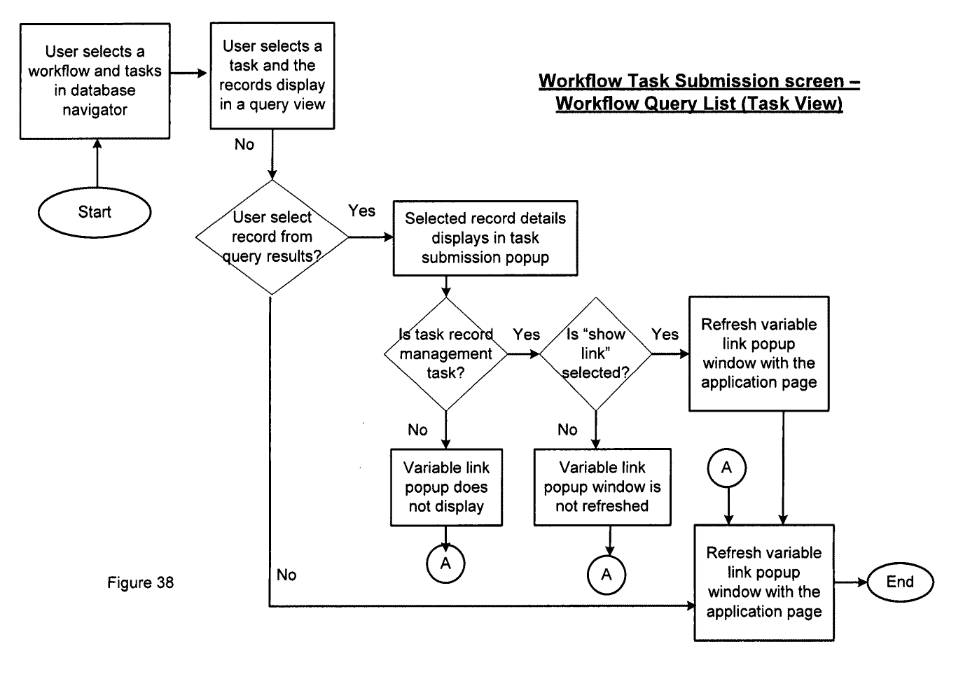

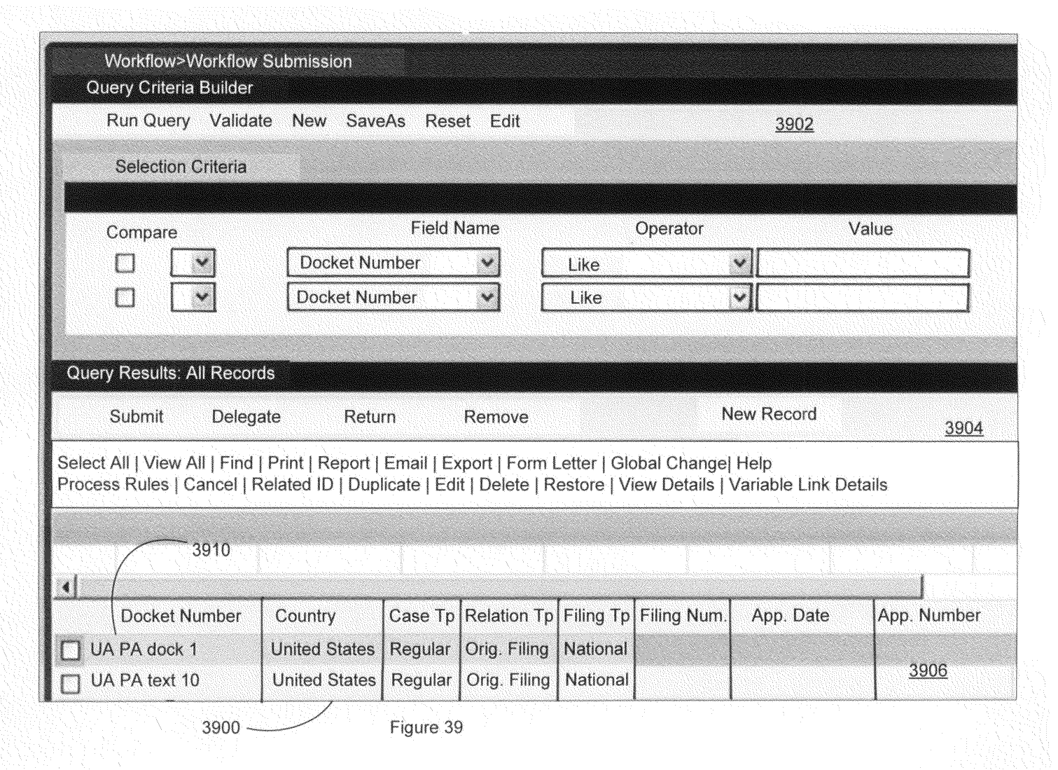

Now with reference to FIGS. 36-38, the improved User Interface includes a Task Submission process. Active and applicable workflow processes and their tasks may be listed in the Navigation pane. FIGS. 36-37 illustrate a workflow associated with the Collaboration Portal or Workflow Navigation Panel, which provides users a query view to display records within a specific task for a process. Users are able to define in the workflow creation module the query to use as format for this view. Users are able to select records within the query and open a submission popup to perform the required task. The user interface lists task records in a Query interface with collaboration operations and opens up task submission window as a popup. This facilitates the decision-making process for large numbers of cases by allowing users to view and edit multiple records on a single screen. Hot keys and links may be provided on the Task Submission popup for Record Management. The user accesses the Task View screen of FIG. 39, described below and established by the workflow process of FIG. 38, from the Collaboration Portal.

In one manner, the IPWM integrates Workflow List View of FIG. 39 with the database navigator or Collaboration Portal to increase database navigator performance and create an integration point for Workflow List. Data Entry (Record Management) may be integrated with Query or Workflow Query. Workflow database (DB) navigator integration includes Task Navigation, e.g., when a user clicks on a New Data Entry task from the DB navigator, the system will pop-up a New Data Entry form and allow the user to enter data. From the DEF (New Data Entry Form), the user can either save the record, which will cause the Workflow to remain at that task, or the user can submit the record to the next task. When the user clicks on a Manual Email Task, the system will pop-up the Available Email Templates window. When the user clicks on a Form Letter Task, the system will pop-up the Available Form Letters window. When the user clicks on a Record Management task, the system will pop a Data Modification Form and will function much the same way as the New Data Entry task does. The consolidated processing of Workflow via the database navigator provides a consistent user interface between query and workflow. The interface is, also, consistent between Data Entry tasks and all other types of workflow tasks as well as the integration with the Data Entry containers.

When a user logs into an IP management application, e.g., Thomson IP Manager, the workflow system may list Collaboration Portal in the navigation pane if the user is an owner of any active process, is delegated to act on any task or is assigned task responsibility to any task. When a user clicks on Collaboration Portal in the navigation pane, the system expands it to list all applicable tasks grouped under its process name, which process listing may be sorted by priority, if assigned, followed by all un-prioritized workflows. When a user clicks on a process in the Collaboration Portal that has a New Data Entry task, the expanded task name listing displays the New Data Entry task name in bold suffixed by an ‘*’. Authorized users are able to add new records to the system from the Collaboration Portal only if the process has a New Data Entry task to which the user is assigned task responsibility or the user is the owner of that process. The Workflow List screen should allow for a query view to display, e.g., the ‘Task View’ screen of FIG. 39. Records within a task with task responsibility assigned to Content Groups may be accessible only if the user is within the specified Content Group. Records within a task with task responsibility assigned to Parties may be accessible if the user is the associated Party for that record. Query results follow the format option selected in the Workflow creation module popup of the query definition that is specified for the Task View screen. If no query format is selected in the workflow creation module popup for a Matter-level process, then the default query source displays the selected audit key fields that are listed in System Configuration for each IP Type. If no query format is selected in the Workflow creation module popup for an Action-level process, then the default query source displays the selected audit key fields that are listed in System Configuration for each IP Type appended with the last column displaying the Action Code or Description as specified in the user preference.

Referring to FIG. 39, in the Task View screen 3900, the query section may contain the following menu bar options: Criteria Builder (Run Query, Validate, Reset) 3902, Query Results Menu Bar options (Select All, Print, Report, Email, Export, Form Letter, Edit, and Variable Links) 3904. All other menu bar options that appear on the Criteria Builder and the Query Results may be disabled. All records in the Query results section 3906 of the Task View screen may be displayed in a single scrollable grid section. Query results in the Task View screen may sort based upon sorting defined in the query definition. The first column of the Query grid in the Task View may be a hyperlink that opens the applicable Task Submission popup 3908 for the selected record 3910. A user selects one, many or all records by selecting the checkbox in the query results set for a given functionality, e.g., <Print>, <Report>, <Email>, <Export>, and <Form Letters>. The Form Letter popup window displays and the user may select a form letter from the popup window to be used with the selected record(s). When a user clicks <Edit> from the Query menu bar options the system opens the Task Submission popup for the selected workflow task, for each record selected in the Query results grid.

The Task View screen includes a Collaboration Toolbar having the following set of menu bar options: <Submit>, <Delegate> (disabled by default), <Remove>, <Return>, and <New Record> (disabled for all tasks but New Data Entry). When an authorized user selects a task from the navigation pane, system opens the Task View with the following details: Query results section (a list of all records currently in that task), Criteria Builder section (for searching for records currently in that task), and Totals and subtotals (as defined in the template). When a user navigates to Task View screen for any applicable task that has a Default Flow and no Threshold defined, selects one or more records and clicks <Submit>, the system moves only the selected records to the next task and refreshes the Query results grid.

When a user navigates to Task View screen for any applicable task that has a User Decision defined, selects one or more records and clicks <Submit>, the system opens the Task Submission popup with a routing question and list of answers. When user selects an answer and clicks <OK>, the system moves only the selected records from the query results to the next task defined against the selected answer, and refreshes the Query results grid.

When an authorized user navigates to Task View screen for any applicable task that has a Default Flow and Threshold defined, selects one or more records and clicks <Submit>, the system moves the selected record(s) only if the record's threshold submission requirement is met. For records that do not meet the submission requirement, the system increases each submission count and drops them from the user who submitted it. These records remain available to other assigned users for task submission until the submission threshold is met, or a defined timed advance modifier time limit is reached.

When a user clicks <Delegate> from the Task View screen for any applicable task with one or more records selected from the query results, the system opens the Task Delegation popup with the list of defined target users. When the user clicks <Delegate> from the Task Delegation pqpup, the system drops only those records selected in the query results set from the delegated user and assigns them to the selected target users. Time elapsed for delegated records is reset to 0 if Alert or Timed Advance is defined.

When an authorized user navigates to the Task View and clicks <Return> with one or more records selected, the system assigns the selected record(s) back to the closest previous manual task. If the target task definition has an Alert or Timed Advance, the elapsed time on the record(s) must be reset to 0. If the target task definition has a Threshold, the submission count for the record(s) should be reset to 0. This will, for example, allow a user to route the matter back to the person who submitted it previously for more information.

The system tracks the route a record takes and uses the same route when assigning a record back to its previous tasks. The Task View screen contains two calculated sums based on the fields selected in the Workflow Details popup. The selected total will be calculated for records that are selected by the user in the Task View screen's results grid using the checkbox. Only the fields selected on the workflow creation module popup are summed. The total is calculated for all records that are in the query results set. If the user has filtered the query result set using the Criteria Builder, the total should reflect only the filtered set. The Selected and Total calculated sums are displayed in the Running Totals section.

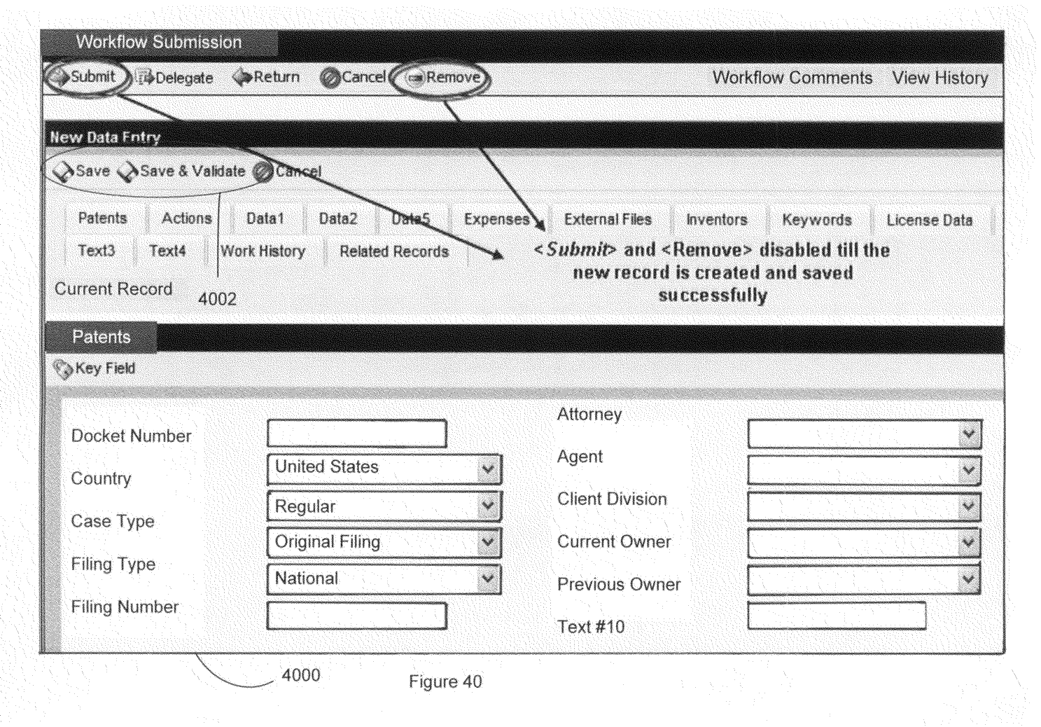

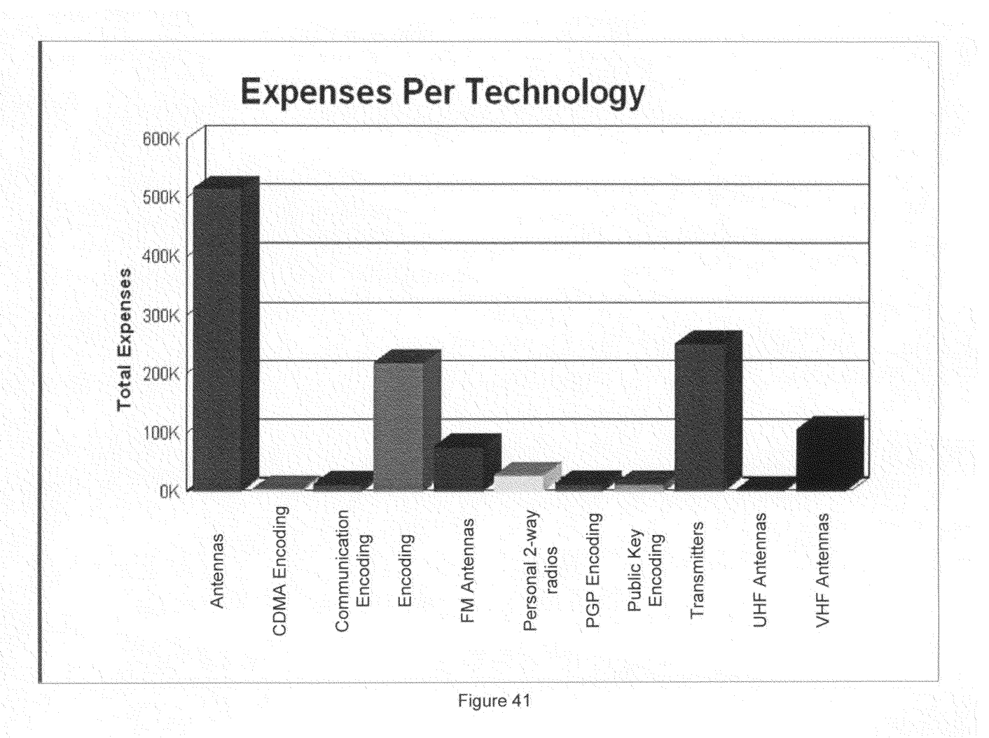

In the Task Submission process, users perform required task operations on a record via a Task Submission popup, such as the New Data Entry Task Submission popup 4000 of FIG. 40, which enables users to continue using IP management software for other functionality. <Save> and <Save & Validate> options 4002 of a Data Entry task work in conjunction with Batch Rules permissions. Data Entry tasks have the <Submit> menu bar option enabled only if there are no unsaved changes. In operation, a record open in a Task Submission popup 4000 may be submitted outside the popup even as the user is working on the task by a different user or by the same user in a different submission popup or from the Task View screen. When a user navigates to the Task View screen and clicks on a record hyperlink listed in the results gird, the system opens up the task in a Task Submission popup for the selected record. The popup window includes an information panel displaying, for example, a checkbox for Show Variable Link (for Record Management task, disabled by default), any record information submission counts if task has a threshold defined, record's elapsed time at the current task if task has Alert or Timed Advance defined. The information panel for a New Data Entry task shows the record elapsed time (if Alert/Timed Advance is defined) only after the new record is created and saved successfully. The Task Submission popup window displaying the executable task preferably contains all custom controls and standard UI associated for that task type with the task's resource.

When a user opens Task Submission popup for a manual Email task, the system displays the generated email for the record. The email generation process uses the Email template defined as the resource for this Email task. When a user clicks on a record from the results grid of the Task View screen for a Form Letter task, the system generates the form letter and opens the Task Submission popup with a blank task pane and displays a File download popup to enable users to download the generated form letter. When a user opens Task Submission popup for a New Data Entry task, the system opens a standard new data entry form using the data form resource defined for the task and provides the following menu bar options: <Save> enabled, <Save & Validate> enabled (provided user has permissions for batch rules and in the event this alternative or additional method of processing rules is implemented in Content group management and User preference, and <Cancel> disabled. When a user opens Task Submission popup for a Record Management task, the system displays the record using the data form resource defined for the task and enables and automatically selects the Show Variable Link checkbox if the task has a variable link defined. Variable link can be defined for a Record Management Task in the Task Designer maintenance popup. When a user opens Task Submission popup for a Record Management task that has a Variable Link defined, the system opens the link (e.g. an external web page related to the IP record) in a separate popup and may refresh the Variable link popup based on the record in display.

When an authorized user clicks <Submit> from the Task Submission popup for Email, Form Letter or New Data Entry task, the system first checks if the record still resides at the current task (i.e., if it has already been submitted to the next task, removed from the process, returned to the previous task, or delegated to a different user). If the record still resides at the current task, the system moves the record to the next task defined and closes the popup. Otherwise, the system notifies the user with an appropriate message and closes the window after user accepts the notification. When the process owner clicks <Remove> from the Task Submission popup for Email, Form Letter or New Data Entry task, the system drops the record from the process, if the record is currently in the process. If the record no longer resides in the current task or anywhere in the current process, the system notifies the user(s) with an appropriate message.

“Purge comments” settings for this process may take effect after the record completes or has been dropped from the workflow. When a user clicks <Return> from the Task Submission popup for Email, Form Letter task, the system first checks if the record still resides at the current task (i.e., if it has already been submitted to the next task, removed from the process, returned to the previous task or delegated to a different user). If the record still resides at the current task, the system assigns the record back to the closest previous manual task. If the target task definition has an Alert or Timed Advance, the elapsed time on the record is reset to 0. If the target task definition has a Threshold, the submission count should be reset to 0. When a user clicks <Return> from the Task Submission popup for Email, Form Letter task, for a record that no longer resides in the current task, the system notifies user with an appropriate message and closes the task submission popup. When a user clicks <Delegate> from the Task Submission popup for Email, Form Letter or New Data Entry task that has Allow Delegation defined, the system first checks if the record still resides at the current task (i.e., if it has already been submitted to the next task, removed from the process, returned to the previous task, or delegated to a different user). If the record still resides at the current task, the system opens the Task Delegation popup. If the record no longer resides in the current task, the system notifies the user with an appropriate message and close the window after the user accepts the notification.

After a successful delegation, record's elapsed time is reset to 0 if the task has an Alert or Timed Advance defined. When an authorized user clicks <Submit>, <Delegate> or <Return> from a Task Submission popup for a Record Management task, the system first checks if the record still resides at the current task. If the record no longer resides in the current task, the system notifies the user with an appropriate message and displays the next record in the result set after user accepts the notification. When an authorized user clicks <Submit> from a Task Submission popup for a Record Management task, for a record that still resides at the current task and the task has a Default Flow with no threshold defined, the system moves the record to the next task defined and displays the next record in the result set. If the current record is the last record in the result set, the system displays an appropriate message in the Information panel and renders the entire data form section as read only. When a user clicks <Submit> from a Task Submission popup for a Record Management task, for a record that still resides at the current task, and the task has a Default Flow with threshold defined, system must check if the current submission meets the required threshold. If the submission meets the threshold, it moves the record to the next task and if the submission does not meet the threshold, it drops the record from the current assigned user. When a user clicks <Submit> from a Task Submission popup for a Record Management task, for a record that still resides at the current task, and the task has an Alternate Flow defined, the system opens the Task Submission popup and displays the defined Question and lists all defined answers.

When an authorized user clicks <Delegate> from a Task Submission popup for a Record Management task for a record that still resides at the current task, the system opens the Task Delegation popup. If the task has an Alert or Timed Advance defined, record's elapsed time must be reset to 0. When an authorized user clicks <Return> from a Task Submission popup for a Record Management task for a record that still resides at the current task, the system assigns the record back to the closest previous manual task and displays the next record in the result set. When the workflow owner clicks <Remove> from the Task Submission popup for a Record management task, the system drops the record from the process, if the record is currently in the process, and “Purge comments” settings for this process take effect. When a user selects <Collaboration Comments> from the Task Submission popup for manual Email, Form Letter or New Data Entry task or Record Management, the system opens a Collaboration Comments popup only if the record resides at the current task for the user and provides the following: multiline read-only text area with the record's previous comments, sorted in descending order by date, multiline text input control for user to enter new collaboration comments, and <Add> and <Cancel> menu bar options.

When an authorized user clicks <Add> from the Collaboration Comments popup after entering a comment, system must save the comment for that record in the database. When a user clicks <View History> from the Task Submission popup for a manual Email, Form Letter or New Data Entry or Record Management task, the system opens a Collaboration History popup only if the record resides at the current task for the user. When a user opens the Collaboration History popup, the system provides the following details: Grid displaying (Process Name, Previous Task, Current Task, Comments, User Date) and <OK> menu bar option. The grid displays the collaboration history sorted in descending by the date column. When a user clicks <Cancel> from the Task Submission popup for any manual task—manual Email, Form Letter, New Data Entry or Record Management task, the system closes the popup. When a user opens a Task Submission popup for a New Data Entry or Record Management task, the system provides <Save> and <Save & Validate> menu options based on Batch Rules permission in the Content group and user preference setup. Users have menu options to save records based on operation of rules depending on the user's permission. For instance, if Content Group permissions and user preference allows ‘Batch Rules processing’ (and providing that alternative type of rules processing is implemented and available), the system provides both <Save> and <Save & Validate> options. If Content Group permissions and user preference does not allow ‘Batch Rules processing’, system provides only <Save> menu bar option. When a user who does not have permissions to run Batch Rules (as specified in Content Group administration and User preference) clicks <Save> in a Task Submission popup for a New Data Entry or Record Management task, the system saves the record to the database and also performs rules validation for that record.

When an authorized user who has permissions to run Batch Rules (as specified in Content Group administration and User preference) clicks <Save> in a Task Submission popup for a New Data Entry or Record Management task, the system only saves the record to the database and does not validate rules for that record. Instead it should mark the record as pending validation.

In setting up workflows, the system is flexible in that it allows authorized users the ability to set up workflows to allow selective editing of active workflows. Having to flush all cases through a workflow, then inactivate it, in order to make any process change may be impractical for an organization that is using workflow to manage collaboration between hundreds of dispersed users working on numerous processes. Also, locking requirements associated with nested workflows would defeat the purpose of nesting if administrators would have to clear the subroutine and all calling workflows in order to make a simple change to the called process. Clearing a workflow process of all cases could take considerable time. Providing a mechanism for editing workflows, while preserving continuity for cases already in a workflow process, will make the functionality more manageable for a large organization. Authorized users may make changes to workflows that do not impact the routing of cases currently within the workflow. Changes that may change the routing of cases (i.e. adding new workflow steps or changing the order of steps) can be accomplished by duplicating the current workflow and making changes to the new copy with a new name. The legacy workflow can be marked as “do not initiate”, meaning that users can no longer initiate the workflow, and timed initiation is inactivated, but users may access and advance any cases already in the legacy workflow. This feature allows users to edit an active workflow. The duplication and activation of the “do not initiate” flag of the legacy workflow can be accomplished manually, or by an automated “baseline” process that the user can initiate.

FIG. 41 is an exemplary graphic representation of an “Investment—Expenses Per Technology” type Report associated with the IPWM. This represents the type of summary reports that might be distributed automatically via a portfolio-level workflow process.

The invention allows for a combination of structured and unstructured interaction and provides workflow modules that allows for creation of structured interaction with IP records. For instance, Thomson IP Manager operating in combination with IPWM would allow simultaneous unstructured interaction with IP records. In addition, an IP record may be a member of more than one workflow being executed simultaneously.

The present invention is not to be limited in scope by the specific embodiments described herein. It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A system for performing Intellectual Property (IP) management workflow processes, comprising:
a central server comprising a processor for executing code, including a workflow program comprised of IP workflow routines executed by the central server and adapted to present via a graphical user interface workflow screens adapted to facilitate the exchange of data and instructions in executing IP workflow routines, the workflow program comprising:
an administration module adapted to create authorized user accounts and to assign roles and privileges associated with the created authorized user accounts involved in execution of IP workflow routines;
a workflow creation module adapted to generate a user interface to facilitate creation of a user-defined IP workflow routine comprising first and second user-defined workflow tasks;
a first user-defined workflow task adapted to process an IP related data set received via a user interface workflow screen; and
a second user-defined workflow task and adapted to process a second data set representing a response to a review associated with the IP related data set; and
a database adapted to store IP related data, including the IP related data set, the database being in communication with and adapted to exchange data with the central server.

2. The system of claim 1 wherein the central server communicates with a first client computer having a user account operating thereon having an authorization established by the administration module.

3. The system of claim 1 further comprising a user interface workflow task screen comprising a workflow task type pulldown menu from which a user may select a desired workflow task type for creating a user-defined workflow task.

4. The system of claim 1 wherein a plurality of client computers are in communication with the central server and wherein workflow screens generated by the IP workflow routines are selectively presented at the plurality of client computers based on the roles and privileges associated with the user accounts operating on the plurality of computers.

5. The system of claim 4 wherein the presentation of the workflow screens is further based on association of the user accounts with the IP workflow routines or with the IP related data being processed by the IP workflow routines.

6. The system of claim 1 wherein the IP workflow routines further include at least one workflow routine from the group consisting of: annuity decision; annuity payments; preparation and filing of application; prosecute application; international filing of application; action review; batch rules process; secondary filing; ad-hoc drop/pay; reminder review; docketing; payment discrepancy management; payment upload; payment status; docket and due date reporting; critical due date review; and licensing review.

7. The system of claim 1 further comprising an IP rules module adapted to generate IP related data based on a defined set of rules relating to rules governing the patent processes before patent authorities.

8. The system of claim 1 further comprising an IP payments module adapted to generate IP related data concerning IP related fees, due dates, and payment status.

9. The system of claim 1 further comprising an IP management application adapted to access, process and modify IP related data stored at the database, and wherein the IP workflow routines are adapted to access and process IP related data stored at the database with simultaneous execution of the IP management application.

10. The system of claim 9 wherein the system allows both structured and unstructured interaction with IP related data and wherein an IP record comprised of IP related data stored at the database may be locked to prevent simultaneous access and modification to the IP related data comprising the IP record.

11. The system of claim 1 further comprising a docket workflow routine adapted to process docket related data and to generate a message for communication to a client computer operating an authorized user account.

12. The system of claim 1 wherein the IP related data includes trademark related data.

13. The system of claim 1 wherein the administration module is further adapted to establish a category hierarchy for classifying IP related data, wherein a plurality of IP related data sets are received via the first workflow routine, and wherein a subset of the plurality of IP related data sets are associated with an established category.

14. The system of claim 13 wherein the established category is characterized by one of the following: technical subject matter, product, project, and business.

15. The system of claim 1 wherein the administrative module is further adapted to create a user group comprised of authorized user accounts and wherein at least one IP workflow routine includes a workflow step that is automatically communicated to all user accounts comprising the user group.

16.

17. The system of claim 1 wherein an IP workflow routine is adapted to interact with other applications to generate at least one of the group consisting of: emails, spreadsheets, correspondence, forms, PDF documents, and electronic messages, in carrying out the business process associated with the IP workflow routine. The system of claim 1 wherein an IP workflow routine generates an email for using in a workflow process, the email including an embedded URL or link to enable the recipient to access the object of the embedded URL or link.

18. The system of claim 1 further comprising a first client computer in browser-based communication with the central server and receiving from the central server a graphical user interface workflow screen related to execution of the first workflow routine and wherein the first client computer communicates signals related to the IP related data set to the central server.

19. The system of claim 1 wherein the workflow creation module further comprises modifiers adapted to be associated with user-defined workflow tasks to further define workflow routine operation.

20. The system of claim 1 further comprising a docket IP workflow routine executed by the central server on a predetermined basis to locate action items associated with IP related data and based on an action code directing subsets of the action items to one or more authorized user accounts assigned responsibility for acting on the subset of action items.

21. The system of claim 20 wherein the docket IP workflow routine is adapted to automatically generate a message to a second authorized user account assigned responsibility for acting on the subset of action items in the event no appropriate action is taken by a first authorized user account assigned primary responsibility.

22. The system of claim 1 further comprising an annuity payment IP workflow routine executable by the central server and adapted to interact with an annuity payment service.

23. The system of claim 1 wherein the database is further adapted to store IP license related information and the system further comprises a license renewal IP workflow routine adapted to query the database for license records identified as terminating within a defined amount of time or by a defined date, the license renewal IP workflow routine further adapted to generate a workflow step to notify based at least in part on an authorized user account.

24. The system of claim 1 wherein the administration module is further adapted to receive user data from either an LDAP or an Active Directory repository.

25. A method for Intellectual Property (IP) management in a computer-based system having a central server executing IP workflow routines and being in communication with a database for storing IP related data, including IP case records, the method comprising:
executing by the central server a user-defined IP workflow routine to generate user interface screens associated with first and second user-defined IP workflow tasks previously created by a workflow creation module, the generated user interface screens for display via client computers operating authorized user accounts;
receiving by the central server a first IP related data set associated with execution of the first user-defined IP workflow task and in association with generation of a first user interface workflow screen;
storing the first IP related data set at the database;
executing by the central server the second user-defined IP workflow task and generating a second user interface workflow screen related to the execution of the second user-defined IP workflow task; and
receiving and processing by the central server data received in response to the generated second user interface workflow screen.

26. The method of claim 25 further comprising selectively presenting user interface workflow task screens associated with the IP workflow routine at a plurality of client computers based on roles and privileges associated with authorized user accounts operating on the plurality of computers.

27. The method of claim 26 wherein the selectively presenting step is further based on association of the authorized user accounts with the IP related data being processed by the IP workflow routine or associated with the user interface workflow task screens being presented.

28. The method of claim 25 further comprising presenting user interface workflow screens associated with at least one workflow routine from the group of workflow routines consisting of: annuity decision; annuity payments; preparation and filing of application; prosecute application; international filing of application; action review; batch rules process; secondary filing; ad-hoc drop/pay; reminder review; docketing; payment discrepancy management; payment upload; payment status; docket and due date reporting; critical due date review; and licensing review.

29. The method of claim 25 further comprising executing at the central server an IP rules module to generate IP related data based on a defined set of rules relating to rules governing the patent processes before patent authorities.

30. The method of claim 25 further comprising executing an IP payments module to generate IP related data concerning IP related fees, due dates, and payment status.

31. The method of claim 25 further comprising generating emails associated with the IP workflow routine.

32. The method of claim 25 further comprising generating at least one from the group consisting of: emails, spreadsheets, correspondence, forms, PDF documents, and electronic messages, in executing the IP workflow routine.

33. The method of claim 25 wherein the IP workflow routine comprises a docket workflow routine that is executed by the central server to process docket related data associated with IP related data and to generate messages for communication to a client computer operating an authorized user account.

34. The method of claim 25 further comprising establishing a category hierarchy for classifying IP related data, wherein a plurality of IP related data sets are received via the first receiving step, and wherein a subset of the plurality of IP related data sets are associated with an established category.

35. The method of claim 34 wherein the established category is characterized by one of the following: technical subject matter, product, project, and business.

36. The method of claim 25 further comprising creating a user group comprised of authorized user accounts and executing at least one IP workflow routine to automatically communicate a workflow step to all user accounts comprising the user group.

37. The method of claim 25 further comprising executing an IP management application adapted to access, process and modify IP related data stored at the database, and wherein the IP workflow routine accesses and processes IP related data stored at the database with simultaneous execution of the IP management application.

38. The method of claim 25 wherein the central server executes the IP workflow routine and the IP management application to allow both structured and unstructured interaction with IP related data stored at the database and wherein an IP record comprised of IP related data stored at the database may be locked to prevent simultaneous access and modification to the IP related data comprising the IP record.

39. The method of claim 25 further comprising executing a docket IP workflow routine on a predetermined basis to locate action items associated with IP related data and, based on an action code, directing subsets of the action items for further handling by other IP workflow routines.

40. The method of claim 39 further comprising generating by execution of the docket IP workflow routine a workflow step comprised of a subset of action items and automatically communicating a workflow response form to a first user account assigned responsibility for the subset of action items.

41. The method of claim 40 further comprising automatically generating by executing the docket IP workflow routine a message to a second user account assigned responsibility in the event no appropriate response associated with the first user account is received.

42. The method of claim 25 further comprising executing an annuity payment IP workflow routine to query the database for data related to upcoming payment events and decisions, and generating a spreadsheet comprising query results and an email for communicating the spreadsheet to a user account or group of user accounts assigned responsibility for managing payment decisions.

43. The method of claim 25 wherein the database is further adapted to store IP license related information, the method further comprising executing a license renewal IP workflow routine to query the database for license records that are identified as terminating within a defined amount of time or by a defined date, and generating a workflow step to notify a user of a license identified by the query.

44. The method of claim 25 further comprising executing the IP workflow routine to generate a request for IP related payment services.

45. In an enterprise network system comprised of client computers, server computers, and a database, an Intellectual Property (IP) management workflow system comprising:
IP management software stored on computer readable memory and executed on a processor, the IP management software being adapted to communicate with a database having stored therein IP related data, including IP case records;
IP workflow module including a graphical user interface (GUI) generator and adapted to enable an authorized user to create a first user-defined IP workflow routine comprised of first and second user-defined workflow tasks and to associate the first user-defined workflow task with a first user account and associate the second user-defined workflow task with a second user account;
the IP workflow module adapted to generate a first GUI for presenting at a computer operating the first user account and being adapted to receive data associated with execution of the first user-defined IP workflow routine and to present via a GUI the first user-defined workflow task and to process a first input associated with the first user-defined workflow task; and
the IP workflow module being adapted to generate a second GUI for presenting at a computer operating the second user account and being adapted to receive data associated with the first user-defined IP workflow routine and to present via a GUI the second user-defined workflow task and to process a second input associated with the second user-defined workflow task, wherein the first and second inputs represent data processed in performing the first user-defined IP workflow routine.

46. The system of claim 45, wherein data associated with the first and second inputs are IP related data and are stored at the database.

47. The system of claim 45, wherein the IP workflow module accesses from the database a first IP related data set in carrying out the first user-defined workflow routine and wherein the IP management software simultaneously performs operations related to the first IP related data set having been accessed for operation in carrying out the first user-defined workflow routine.

48. The system of claim 45, wherein the IP management software executes on a network server computer and is at least in part browser-based.

49. The system of claim 45, wherein the IP workflow module is software executing on a network server computer and is at least in part browser-based.

50. The system of claim 45, wherein the IP management software comprises server software and client software.

51. A computer-based method for automating and managing workflow for data intake, retrieval, display, and decision management in performing Intellectual Property (IP) related workflow processes, the method comprising:
electronically receiving an invention disclosure submission associated with a first authorized user account and storing data related to the invention disclosure submission at a database;
executing a first user-defined IP workflow routine comprising a first user-defined workflow task and generating a first workflow task screen prompting action from a second authorized user account relating to review of the invention disclosure submission;
receiving for processing by the first IP workflow routine a first response relating to a filing decision concerning the invention disclosure submission and storing data related to the first response at the database;
executing the first user-defined IP workflow routine to associate a third entity with the task of preparing and filing a patent application concerning the invention disclosure submission; and
executing the first user-defined IP workflow routine to perform a docketing function associated with the invention disclosure submission.

52. The method of claim 51 further comprising automatically executing a rules-based workflow task to determine target filing dates associated with the invention disclosure submission.

53. The method of claim 51 further comprising processing by the first user-defined IP workflow routine a request for information relating to the invention disclosure submission and executing a second user-defined workflow task to present a workflow task screen comprising a prompt for information related to the invention disclosure submission at a computer operating an authorized user account other than the second authorized user account.

54. The method of claim 51, wherein the first and second authorized user accounts are associated with employees of a first business concern and the third entity represents legal counsel from outside the first business concern.

55. The method of claim 51 further comprising automatically generating by the first user-defined IP workflow routine an engagement letter associated with preparation of a patent application for sending to the third entity.

56. A computer-based method for creating user-defined IP workflow routines in an Intellectual Property (IP) management system, the system including a central server executing IP workflow routines and a database for storing IP related data, the method comprising:
creating authorized user accounts and associating the created user accounts with roles and privileges involved in execution of IP workflow routines and processing IP related data stored at the database;
executing by the central server a workflow creation module to generate user interface screens; and
generating a signal adapted to be presented at a computer operating an authorized user account a plurality of workflow task creation screens and receiving inputs via the computer in response to the plurality of workflow task creation screens, whereby a user-defined IP workflow routine comprised of first and second user-defined IP workflow tasks is created.

57. The method of claim 56 wherein presenting the plurality of workflow task creation screens further comprises presenting via a user interface a workflow task type pulldown menu comprising a plurality of workflow task types from which to choose in creating a user-defined workflow task.

58. The method of claim 56 further comprising assigning a task modifier to a user-defined workflow task, the modifier determining in part the operation of the user-defined IP workflow routine.

59. The method of claim 58, wherein the task modifier directs the IP workflow routine to one of a plurality of workflow tasks based on a predefined event.

60. The method of claim 59, wherein the predefined event is one of the group consisting of: timed advance; time expiration; alert condition; threshold number of responses; user delegation; default flow; alternate flow; conditional routing; and user response.

61. The method of claim 56 wherein a user-defined IP workflow task is one of the group consisting of: action-level; portfolio-level; and case-level.
